(19) United States
(12) Patent Application Publication
(10) Pub. No.: US 2026/0055269 A1
(43) Pub. Date: Feb. 26, 2026

(54) COATING COMPOSITIONS

(71) Applicant: PPG Industries Ohio, Inc., Cleveland, OH (US)

(72) Inventors: David Joseph Fortman, Pittsburgh, PA (US); Marvin Michael Pollum, Jr., Pittsburgh, PA (US); Joseph Peter Kriley, Valencia, PA (US); JianCheng Liu, Arcadia, CA (US); Razmik Boghossian, Thousand Oaks, CA (US); Kedar Mikel Parker, Los Angeles, CA (US)

(73) Assignee: PPG Industries Ohio, Inc., Cleveland, OH (US)

(21) Appl. No.: 19/102,990

(22) PCT Filed: Jun. 16, 2023
(86) PCT No.: PCT/US2023/068597

§ 371 Date: Feb. 11, 2025

Related U.S. Application Data
(60) Provisional application No. 63/371,590, filed on Aug. 16, 2022.
(60) Provisional application No. 63/384,551, filed on Nov. 21, 2022.

(51) Int. Cl. C08L 63/00; C09D 7/65; C09D 163/00; C09J 5/00; C09J 11/08; C09J 163/00

(52) U.S. Cl. CPC C08L 63/00; C09D 7/65; C09D 163/00; C09J 5/00; C09J 11/08; C09J 163/00; C08L 2205/025; C08L 2205/03

(57) ABSTRACT

Disclosed herein are compositions comprising a first component comprising an epoxy-containing compound (E1), a second component comprising an amine-functional aliphatic etheramine-epoxy adduct (A1), elastomeric particles, and an auxiliary toughening agent. Also disclosed are coated substrates and methods for forming a coating on a substrate.

### CROSS-REFERENCE TO RELATED APPLICATIONS

This application claims priority to U.S. Provisional Application No. 63/371,590, filed on Aug. 16, 2022, entitled “Coating Compositions,” and U.S. Provisional Application No. 63/384,551, filed on Nov. 21, 2022, entitled “Coating Compositions,” both incorporated herein by reference in their entireties.

### GOVERNMENT CONTRACT

This disclosure was made with Government support under Government Contract No. 201867-140932 entitled Consolidation of Adhesives and Sealants Phase II FY17 awarded by the Combat Capabilities Development Command Ground Vehicle Systems Center. The United States Government may have certain rights in this disclosure.

### FIELD

The present disclosure relates to compositions and coatings formed therefrom.

### BACKGROUND

Coating compositions, including adhesives, are utilized in a wide variety of applications to treat a variety of substrates or to bond together two or more substrate materials.

### SUMMARY

The present disclosure is directed to a composition comprising: a first component comprising an epoxy-containing compound (E1); a second component comprising an amine-functional aliphatic etheramine-epoxy adduct (A1); elastomeric particles; and an auxiliary toughening agent.

The present disclosure also is directed to a method of coating a substrate comprising contacting a portion of the substrate with any of the compositions disclosed herein.

The present disclosure also is directed to a method of forming an article, comprising extruding any of the compositions disclosed herein.

The present disclosure also is directed to an article formed by any of the methods disclosed herein.

The present disclosure also is directed to a substrate comprising a coating formed from any of the compositions disclosed herein on a portion of a surface of the substrate.

The present disclosure also is directed to a use of any of the compositions disclosed herein for coating a surface of a substrate, wherein the coating comprises (a) a lap shear strength of at least 25 MPa measured according to ASTM D1002-10 using 2024-T3 aluminum substrate of 1.6 mm thickness using an INSTRON 5567 machine in tensile mode with a pull rate of 1.3 mm per minute; (b) a wedge impact peel resistance at ambient temperature of at least 10 N/mm and (c) a wedge impact peel resistance at −40° C. of at least 3.0 N/mm, wherein wedge impact peel resistance at both ambient and −40° C. tested according to ISO 11343 Dynamic Resistance to Cleavage testing using 5754 aluminum substrate of 1.2 mm thickness using an INSTRON CEAST 9350 drop tower model at an impact speed of 2 m/sec, with samples being conditioned at the desired temperature for at least 30 minutes before testing.

### DETAILED DESCRIPTION

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims, are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing,” and like terms are understood in the context of this application to be synonymous with “comprising” and are therefore open-ended and do not exclude the presence of additional undescribed or unrecited elements, materials, ingredients, or method steps. As used herein, open-ended terms include closed terms such as consisting essentially of and consisting of.

As used herein, “consisting of” is understood in the context of this application to exclude the presence of any unspecified element, ingredient, or method step.

As used herein, “consisting essentially of” is understood in the context of this application to include the specified elements, materials, ingredients, or method steps “and those that do not materially affect the basic and novel characteristic(s)” of what is being described.

In this application, the use of the singular includes the plural and plural encompasses singular, unless specifically stated otherwise. For example, although reference is made herein to “an” epoxy-containing compound and “an” amine-functional aliphatic etheramine-epoxy adduct, a combination (i.e., a plurality) of these components may be used.

In addition, in this application, the use of “or” means “and/or” unless specifically stated otherwise, even though “and/or” may be explicitly used in certain instances.

As used herein, the terms “on,” “onto,” “applied on,” “applied onto,” “formed on,” “deposited on,” “deposited onto,” “injected on,” “injected onto” and the like mean formed, overlaid, deposited, or provided on, but not necessarily in contact with, a substrate surface. For example, a composition “applied onto” a substrate surface does not preclude the presence of one or more other intervening coatings of the same or different composition located between the composition and the substrate surface.

As used herein, a “composition” or “coating composition” refers to a solution, mixture, or a dispersion, that is capable of producing a coating on a portion of a substrate. “Coating” as used herein includes films, layers and the like.

As used herein, the term “adhesive” means a coating producing a load-bearing joint.

As used herein, the term “structural adhesive” means an adhesive producing a load-bearing joint having both a lap shear strength of at least 10 MPa measured according to ASTM D1002-10 using 2024-T3 aluminum substrate of 1.6 mm thickness using an INSTRON 5567 machine in tensile mode with a pull rate of 1.3 mm per minute.

As used herein, the term “pottant” refers to an encapsulant.

As used herein, the term “gap filler” refers to a coating that fills a gap.

As used herein, the term “pre-preg” refers to a composition pre-impregnating reinforcement fibers prior to cure.

As used herein, the term “liquid shim” refers to a coating that eliminates gaps between substrate surfaces.

As used herein, the term “two-component” or “2K” refers to a composition which cures without activation from an external energy source, such as at ambient or slightly thermal conditions, when mixed. “Ambient” conditions generally refer to room temperature and humidity conditions and may be 10° C. to 32° C. and 20% relative humidity to 80% relative humidity, while slightly thermal conditions are slightly above ambient temperature (e.g., 32° C. to 40° C.). One of skill in the art understands that the two components of the composition are stored separately from each other and mixed just prior to application of the composition. Two-component compositions may optionally be heated or baked, as described below.

As used herein, the term “cure” or “curing”, means that the components that form the composition interact or react to form a coating as demonstrated by an increase in viscosity when measured after mixing the first and the second components. Unless indicated to the contrary, viscosity disclosed herein may be measured at ambient conditions according to Brookfield viscometer (e.g., model DV2T) using an appropriate spindle size based on viscosity of the composition.

The term “curable”, as used for example in connection with a coating composition, means that the composition is able to be cured under ambient or slightly thermal conditions.

As used herein, “monoamine” refers to an organic compound having one amino functional group.

As used herein, “diamine” refers to an organic compound having two amino functional groups.

As used herein, “polyamine” refers to an organic compound having more than two amino functional groups.

As used herein, “amino functional group” refers to a functional group comprising a nitrogen atom attached by a single bond to a hydrogen atom(s), an alkyl group(s), and/or an aryl group(s).

As used herein, “epoxide functional group” refers to a functional group comprising a cyclic ether with a three-atom ring.

As used herein, “amine hydrogen” refers to the number of active hydrogens directly bonded to the nitrogen atom of an amine- or another nitrogen-containing functional group. “Active hydrogens” refer to hydrogens that can be displaced when the amine- or nitrogen-containing functional group reacts as a nucleophile with an appropriate electrophile and can be determined, for example, by the Zerewitinoff test. Active hydrogens on all accelerators and curing agents (e.g., diamines and/or polyamines) were included in the amine hydrogens of the adducts and compositions of the present disclosure.

As used herein, the “epoxide equivalent weight” refers to the weight of material in grams containing one stoichiometric equivalent of epoxy functional groups. The epoxide equivalent weight may be determined theoretically by dividing the theoretical molecular weight of the material by the average number of epoxy groups present in the material. The epoxide equivalent weight may be determined experimentally, for example, by titration of a sample using a Metrohm 808 or 888 Titrando, using a sample 0.06 g per 100 g/eq of predicted epoxy equivalent weight and dissolving the sample in 20 mL of methylene chloride or tetrahydrofuran and then adding 40 mL glacial acetic acid and one gram of tetraethylammonium bromide before titration with 0.1 N perchloric acid in glacial acetic acid.

As used herein, the “hydroxide equivalent weight” refers to the weight of material in grams containing one stoichiometric equivalent of hydroxyl functional groups. The hydroxide equivalent weight may be determined theoretically by dividing the theoretical molecular weight of the polymer by the average number of hydroxy groups present in the polymer or experimentally by an appropriate titration method such as those outlined in Method A or B of ASTM E222-10 (2010).

As used herein, the “amine hydrogen equivalent weight” refers to the weight of material in grams containing one stoichiometric equivalent of amine hydrogen functional groups. The amine hydrogen equivalent weight may be determined theoretically by dividing the theoretical molecular weight of the material by the average number of amine hydrogen groups present in the material or experimentally by an appropriate titration method such as those outlined in ASTM D2073 or ASTM D2896.

As used herein, the “acrylate equivalent weight” refers to the weight of material in grams containing one stoichiometric equivalent of acrylate functional groups. The acrylate equivalent weight may be determined theoretically by dividing the theoretical molecular weight of the material by the average number of acrylate groups present in the material.

As used herein, the “acetoacetyl equivalent weight” refers to the weight of material in grams containing one stoichiometric equivalent of acetoacetyl functional groups. The acetoacetyl equivalent weight may be determined theoretically by dividing the theoretical molecular weight of the material by the average number of acetoacetyl groups present in the material.

As used herein, the “ketone equivalent weight” refers to the weight of material in grams containing one stoichiometric equivalent of ketone functional groups. The ketone equivalent weight may be determined theoretically by dividing the theoretical molecular weight of the material by the average number of ketone groups present in the material.

As used herein, the “aldehyde equivalent weight” refers to the weight of material in grams containing one stoichiometric equivalent of aldehyde functional groups. The aldehyde equivalent weight may be determined theoretically by dividing the theoretical molecular weight of the material by the average number of aldehyde groups present in the material.

As used herein, the “isocyanate equivalent weight” refers to the weight of material in grams containing one stoichiometric equivalent of isocyanate functional groups. The isocyanate group may be determined theoretically by dividing the theoretical molecular weight of the material by the average number of isocyanate groups present in the material or experimentally by a titration method such as those outlined in ASTM D5155 or ASTM D2572.

As used herein, the “thiol equivalent weight” refers to the weight of material in grams containing one stoichiometric equivalent of thiol functional groups. The thiol equivalent weight may be determined theoretically by dividing the theoretical molecular weight of the material by the average number of thiol groups present in the material.

As used herein, “Mw” refers to the weight average molecular weight, for example the theoretical value as determined by Gel Permeation Chromatography using Waters 2695 separation module with a Waters 410 differential refractometer (RI detector) and polystyrene standards, tetrahydrofuran (THF) used as the eluent at a flow rate of 1 ml min⁻¹, and two PL Gel Mixed C columns used for separation.

As used herein, “polymer” refers oligomers, homopolymers, and copolymers.

As used herein, “small molecule” refers to a molecule that comprises discrete chemical structures, has a molecular weight of less than 1200 g/mol and that is not a polymer (i.e., is not composed of repeating monomer units). The molecular weight of a small molecule may be determined by mass spectrometry. Appropriate mass spectrometry methods for various types of small molecules are available in many references, such as, Mass Spectrometry: A Textbook (3^{rd} Edition, 2018, edited by Jurgen Gross).

As used herein, the term “reactive diluent” refers to a molecule or a compound that is used to lower the viscosity of a formulation and that has a functional group capable of reacting with a functional group(s) on molecules or compounds in a composition.

As used herein, the term “plasticizer” refers to a molecule or a compound that does not have a functional group capable of reacting with a functional group(s) on molecules or compounds in a composition and that is added to the composition to decrease viscosity, decrease glass transition temperature (Tg), and impart flexibility.

As used herein, the term “accelerator” means a substance that increases the rate or decreases the activation energy of a chemical reaction in comparison to the same reaction in the absence of the accelerator. An accelerator may be either a “catalyst,” that is, without itself undergoing any permanent chemical change, or may be reactive, that is, capable of chemical reactions and includes any level of reaction from partial to complete reaction of a reactant.

As used herein, unless indicated otherwise, the term “substantially free” means that a particular material is not purposefully added to a mixture or composition and is present only as an impurity in a trace amount of less than 5 percent by weight based on a total weight of the mixture or composition.

As used herein, unless indicated otherwise, the term “essentially free” means that a particular material is present only in an amount of less than 2 percent by weight based on a total weight of the mixture or composition.

As used herein, unless indicated otherwise, the term “completely free” means that a mixture or composition does not comprise a particular material, i.e., the mixture or composition comprises 0% by weight of such material.

Disclosed herein is a composition comprising, or consisting essentially of, or consisting of: a first component comprising an epoxy-containing compound (E1); and a second component comprising an amine-functional aliphatic etheramine-epoxy adduct (A1); elastomeric particles; and an auxiliary toughening agent.

### First Component

As discussed above, the first component of the composition may comprise an epoxy-containing compound (E1).

Useful epoxy-containing compounds (E1) that can be used include polyepoxides (having an epoxy functionality greater than 1), epoxy adducts, or combinations thereof. Suitable polyepoxides include polyglycidyl ethers of Bisphenol A, such as Epon® 828 and 1001 epoxy resins, and Bisphenol F polyepoxides, such as Epon® 862, which are commercially available from Hexion Specialty Chemicals, Inc. Other useful polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, and epoxy novolac resins. Still other non-limiting epoxy components include epoxidized Bisphenol A novolacs, epoxidized phenolic novolacs, epoxidized cresylic novolac, isosorbide diglycidyl ether, triglycidyl p-aminophenol, and triglycidyl p-aminophenol bismaleimide, triglycidyl isocyanurate, tetraglycidyl 4,4′-diaminodiphenylmethane, tetraglycidyl methylene dianiline, tetraglycidyl m-xylyenediamine and tetraglycidyl 4,4′-diaminodiphenylsulphone. The epoxy-containing compound may also comprise an epoxy-containing acrylic, such as glycidyl methacrylate.

The epoxy-containing compound (E1) may comprise an epoxide equivalent weight of at least 80 g/eq, such as at least 120 g/eq. The epoxy-containing compound (E1) may comprise an epoxide equivalent weight of no more than 300 g/eq, such as no more than 220 g/eq. The epoxy-containing compound (E1) may comprise an epoxide equivalent weight of 80 g/eq to 300 g/eq, such as 120 g/eq to 220 g/eq.

The first component may comprise epoxy-containing compounds of two or more types. That is, the epoxy-containing compound (E1) may comprise a first epoxy-containing compound and may further comprise, e.g., a second, a third, and/or a fourth, etc., epoxy-containing compound (E1) in addition to the first epoxy-containing compound (E1). As used herein with respect to epoxy-containing compounds (E1), reference to “first,” “second,” “third,” etc. is for convenience only and does not refer to order of addition to the composition or the like.

The second, third, fourth, etc. epoxy-containing compound (E1) may be any of the epoxy-containing compounds described above. For example, the epoxy-containing compound may comprise a first epoxy-containing compound comprising a diepoxide and a second epoxy-containing compound comprising a triepoxide and/or a third epoxy-containing compound comprising a tetraepoxide.

The first component optionally may include an epoxy-containing reactive diluent such as those known typically used in coating compositions such as adhesive compositions and such reactive diluents may be included as an epoxy-containing compound (E1).

The first component may comprise the epoxy-containing compound (E1) in an amount of at least 10 percent by weight based on total weight of the first component, such as 20 percent by weight. The first component may comprise the epoxy-containing compound (E1) in an amount of no more than 100 percent by weight based on total weight of the first component, such as no more than 80 percent by weight. The first component may comprise the epoxy-containing compound (E1) in an amount of 10 percent by weight to 100 percent by weight based on total weight of the first component, such as 20 percent by weight to 80 percent by weight.

The first component may further comprise a monoepoxide. Suitable monoepoxides that may be used include glycidol, monoglycidyl ethers of alcohols and phenols, such as phenyl glycidyl ether, n-butyl glycidyl ether, cresyl glycidyl ether, isopropyl glycidyl ether, glycidyl versatate, for example, CARDURA E available from Shell Chemical Co., and glycidyl esters of monocarboxylic acids such as glycidyl neodecanoate, and mixtures of any of the foregoing.

The first component may comprise the monoepoxide, if present at all, in an amount of at least 1 percent by weight based on total weight of the first component. The first component may comprise the monoepoxide in an amount of no more than 30 percent by weight based on total weight of the first component, such as no more than 20 percent by weight. The first component may comprise the monoepoxide, if present at all, in an amount of up to 30 percent by weight based on total weight of the first component, such as 1 percent by weight to 30 percent by weight, such as 1 percent by weight to 30 percent by weight.

### Second Component

As described above, the second component of the composition may comprise an amine-functional aliphatic etheramine-epoxy adduct (A1). As used herein, the term “amine-functional aliphatic etheramine-epoxy adduct (A1) refers to a reaction product comprising the reside of an aliphatic etheramine (A2) and an epoxy-containing compound (E2), wherein the amine hydrogen functionality of A2 is in molar excess relative to the epoxide functionality of E2. As used herein, the term “etheramine” refers to an amine comprising an ether linkage.

The amine-functional aliphatic etheramine-epoxy adduct (A1) may be substantially free or completely free, of epoxide-functional groups. As used herein, the term “substantially free,” when used with respect to the absence of an epoxide-functional group, means that the amine-functional aliphatic etheramine-epoxy adduct (A1) comprises an epoxide equivalent weight of greater than 2000. As used herein, the term “completely free,” when used with respect to the absence of epoxide-functional groups, means that such functional groups are below the limit of detection of common analytical techniques.

The second component may comprise amine-functional aliphatic etheramine-epoxy adducts of two or more types. That is, the amine-functional aliphatic etheramine-epoxy adduct (A1) may comprise a first amine-functional aliphatic etheramine-epoxy adduct and may further comprise, e.g., a second, a third, and/or a fourth, etc., amine-functional aliphatic etheramine-epoxy adduct (A1) in addition to the first amine-functional aliphatic etheramine-epoxy adduct (A1). As used herein with respect to amine-functional aliphatic etheramine-epoxy adduct (A1), reference to “first,” “second,” “third,” etc. is for convenience only and does not refer to order of addition to the composition or the like.

The second, third, fourth, etc. amine-functional aliphatic etheramine-epoxy adduct (A1) may be any of the amine-functional aliphatic etheramine-epoxy adducts described above.

The second component may comprise the amine-functional aliphatic etheramine-epoxy adduct (A1) in an amount of at least 10 percent by weight based on total weight of the second component, such as at least 20 weight percent. The second component may comprise the amine-functional aliphatic etheramine-epoxy adduct (A1) in an amount of no more than 100 weight percent based on total weight of the second component, such as no more than 98 weight percent. The second component may comprise the amine-functional aliphatic etheramine-epoxy adduct (A1) in an amount of 10 weight percent to 100 weight percent based on total weight of the second component, such as at least 20 weight percent to 98 weight percent.

The amine-functional aliphatic etheramine-epoxy adduct (A1) may comprise a reaction product of reactants comprising an aliphatic etheramine (A2) and an epoxy-containing compound (E2).

The aliphatic etheramine (A2) may comprise at least two amine-functional groups. For example, the aliphatic etheramine (A2) may comprise a diamine and/or a polyamine, such as a triamine, a tetraamine, or combinations thereof.

The aliphatic etheramine (A2) may comprise an ethylene glycol subunit. The term “comprising at least one ethylene glycol subunit” indicates that the etheramine contains at least one structure R(CH₂CH₂O)ₙR, wherein R may represent any organic substituent, including by way of non-limiting examples, carbon-, hydrogen-, nitrogen- and/or oxygen-based substituents and wherein n=1 to 5.

The aliphatic etheramine (A2) may comprise a primary amine functional group adjacent to a methylene group. The term “comprising a primary amine functional group adjacent to a methylene group” indicates that the etheramine contains a structure RCH₂NH₂ wherein R may represent any organic substituent, including by way of non-limiting examples, carbon-, hydrogen-, and/or oxygen-based substituents.

Useful aliphatic etheramines (A2) include ethylene glycol bis(2-aminoethyl) ether (available as Jeffamine EDR-148 from Huntsman), diethylene glycol bis(2-aminoethyl) ether, diethylene glycol bis(3-aminopropyl) ether (available as Ancamine 1922A from Evonik or Baxxodur EC 130 from BASF), bis(aminopropyl) 1,4-butanediol (available from BASF SE) or combinations thereof.

The aliphatic etheramine (A2) may comprise a molecular weight of at least 104 g/mol, such as at least 140 g/mol. The aliphatic etheramine may comprise a molecular weight of no more than 300 g/mol, such as no more than 230 g/mol. The aliphatic etheramine may comprise a molecular weight of 104 g/mol to 300 g/mol, such as 140 g/mol to 230 g/mol. The molecular weight of the aliphatic etheramine (A2) may be measured using mass spectrometry as described hereinabove.

As discussed above, the reactants for forming the amine-functional aliphatic etheramine-epoxy adduct (A1) may comprise an epoxy-containing compound (E2). The epoxy-containing compound (E2) may be any of the monoepoxides and/or polyepoxides disclosed above. For example, the epoxy-containing compound (E2) may comprise bisphenol A diglycidyl ether, bisphenol F diglycidyl ether, a novolac resin, tetraglycidyl methylene dianaline, triglycidyl-p-amino phenol, tetraglycidyl m-xylenediamine or combinations thereof.

The epoxy-containing compound (E2) may comprise a small molecule. For example, the epoxy-containing compound (E2) may comprise a molecular weight of no more than 600 g/mol, such as no more than 450 g/mol. The epoxy-containing compound (E2) may comprise a molecular weight of at least 160 g/mol, such as at least 300 g/mol. The epoxy-containing compound (E2) may comprise a molecular weight of 160 g/mol to 600 g/mol, such as 300 g/mol to 450 g/mol. Molecular weight of the epoxy-containing compound (E2) may be determined by mass spectrometry as described hereinabove.

The epoxy-containing compound (E2) may comprise an epoxide equivalent weight of at least 85 g/eq, such as 110 g/eq. The epoxy-containing compound (E2) may comprise an epoxide equivalent weight of no more than 300 g/eq, such as no more than 220 g/eq. The epoxy-containing compound (E2) may comprise an epoxide equivalent weight of 85 g/eq to 300 g/eq, such as 110 g/eq to 220 g/eq.

Optionally, the epoxy-containing compound (E2) may comprise an aromatic group.

Suitable examples of epoxy-containing compounds (E2) include bisphenol A diglycidyl ether, bisphenol F diglycidyl ether, a novolac resin, tetraglycidyl methylene dianaline, triglycidyl-p-amino phenol, tetraglycidyl m-xylenediamine, a hydrogenated bisphenol A diglycidyl ether (such as those commercially available as Eponex 1510), butanediol diglycidyl ether or combinations thereof.

The reactants may comprise the aliphatic etheramine (A2) in an amount sufficient to provide a molar ratio of amine-hydrogens from the aliphatic etheramine (A2) to epoxide functional groups from the epoxy-containing compound (E2) of at least 3:1, such as at least 4:1. The reactants may comprise the aliphatic etheramine (A2) in an amount sufficient to provide a molar ratio of amine-hydrogens from the aliphatic etheramine (A2) to epoxide functional groups from the epoxy-containing compound (E2) of no more than 12:1, such as no more than 7:1. The reactants may comprise the aliphatic etheramine (A2) in an amount sufficient to provide a molar ratio of amine-hydrogens from the aliphatic etheramine (A2) to epoxide functional groups from the epoxy-containing compound (E2) of 3:1 to 12:1, such as 4:1 to 7:1.

The second component optionally may include an amine-containing reactive diluent such as those typically used in coating compositions such as adhesive compositions and such reactive diluents may be included in the calculation of amine-hydrogens present in the second component.

Optionally, the second component may be substantially free, or essentially free, or completely free, of cycloaliphatic amines. As used herein, the term “cycloaliphatic amine” means aliphatic amines comprising a cyclic structure.

### Elastomeric Particles

The composition may further comprise elastomeric particles. The elastomeric particles may be in a first component, the second component, a third or higher component or combinations thereof. As used herein, “elastomeric particles” refers to particles comprised of one or more materials having a glass transition temperature (Tg) of greater than −150° C. and less than 30° C., calculated, for example, using the Fox Equation or measured, for example, using differential scanning calorimetry. As used herein, the term “glass transition temperature” (“Tg”) refers to the temperature at which an amorphous material, such as glass or a polymer, changes from a brittle vitreous state to a plastic state or from a plastic state to a brittle vitreous state.

The elastomeric particles may be phase-separated from the epoxy-containing component. As used herein, the term “phase-separated” means forming a discrete domain within a matrix of the epoxy-containing component.

The elastomeric particles may have a core/shell structure. Suitable core-shell elastomeric particles may be comprised of an acrylic shell and an elastomeric core. The core may comprise natural or synthetic rubbers, polybutadiene, styrene-butadiene, polyisoprene, chloroprene, acrylonitrile butadiene, butyl rubber, polysiloxane, polysulfide, ethylene-vinyl acetate, fluoroelastomer, polyolefin, or combinations thereof. The elastomeric particles may comprise a polybutadiene core, a styrene butadiene core, and/or a polysiloxane core. As used herein, the “elastomeric particles” are not part of the auxiliary toughening agent described below.

According to the present disclosure, the average particle size of the elastomeric particles may be at least 20 nm as measured by transmission electron microscopy (TEM), such as at least 30 nm, such as at least 50 nm. The average particle size of the elastomeric particles may be no more than 300 nm as measured by transmission electron microscopy (TEM), such as no more than 200 nm, such as no more than 150 nm. According to the present disclosure, the average particle size of the elastomeric particles may be 20 nm to 300 nm as measured by TEM, such as 30 nm, to 200 nm, such as 50 nm to 150 nm. Suitable methods of measuring particle sizes by TEM include suspending elastomeric particles in a solvent selected such that the particles do not swell, and then drop casting the suspension onto a TEM grid which is allowed to dry under ambient conditions. For example, epoxy resin containing core-shell rubber elastomeric particles from Kaneka Texas Corporation can be diluted in butyl acetate for drop casting. Particle size measurements may be obtained from images acquired using a Tecnai T20 TEM operating at 200 kV and analyzed using ImageJ software, or an equivalent instrument and software.

According to the present disclosure, the elastomeric particles may optionally be included in an epoxy carrier resin for introduction into the coating composition. Suitable finely dispersed core-shell elastomeric particles comprising an average particle size as described above may be master-batched in epoxy resin such as aromatic epoxides, phenolic novolac epoxy resin, bisphenol A and/or bisphenol F diepoxide, and/or aliphatic epoxides, which include cyclo-aliphatic epoxides, at concentrations ranging from 1% to 80% core-shell elastomeric particles by weight based on the total weight of the elastomeric dispersion, such as from 5% to 50%, such as from 15% to 35%. Suitable epoxy resins may also include a mixture of epoxy resins. When utilized, the epoxy carrier resin may be an epoxy-containing component of the present disclosure such that the weight of the epoxy-containing component present in the coating composition includes the weight of the epoxy carrier resin.

Exemplary non-limiting commercial core-shell elastomeric particle products using poly(butadiene) rubber particles that may be utilized in the coating composition of the present disclosure include core-shell poly(butadiene) rubber powder (commercially available as PARALOID™ EXL 2650A from Dow Chemical), a core-shell poly(butadiene) rubber dispersion (25% core-shell rubber by weight) in bisphenol F diglycidyl ether (commercially available as Kane Ace MX 136), a core-shell poly(butadiene) rubber dispersion (33% core-shell rubber by weight) in Epon® 828 (commercially available as Kane Ace MX 153), a core-shell poly(butadiene) rubber dispersion (33% core-shell rubber by weight) in Epiclon® EXA-835LV (commercially available as Kane Ace MX 139), a core-shell poly(butadiene) rubber dispersion (37% core-shell rubber by weight) in bisphenol A diglycidyl ether (commercially available as Kane Ace MX 257), and a core-shell poly(butadiene) rubber dispersion (37% core-shell rubber by weight) in Epon® 863 (commercially available as Kane Ace MX 267), each available from Kaneka Texas Corporation.

Exemplary non-limiting commercial core-shell elastomeric particle products using styrene-butadiene rubber particles that may be utilized in the coating composition include a core-shell styrene-butadiene rubber powder (commercially available as CLEARSTRENGTH® XT100 from Arkema), an MMA-Styrene-Butadiene core shell rubber (commercially available as Clearstrength XT 100 from Arkema), a core-shell styrene-butadiene rubber powder (commercially available as PARALOID™ EXL 2650J), a core-shell styrene-butadiene rubber dispersion (33% core-shell rubber by weight) in bisphenol A diglycidyl ether (commercially available as Fortegra™ 352 from Olin™), a core-shell styrene-butadiene rubber dispersion (33% rubber by weight) in low viscosity bisphenol A diglycidyl ether (commercially available as Kane Ace MX 113), a core-shell styrene-butadiene rubber dispersion (25% core-shell rubber by weight) in bisphenol A diglycidyl ether (commercially available as Kane Ace MX 125), a core-shell styrene-butadiene rubber dispersion (25% core-shell rubber by weight) in bisphenol F diglycidyl ether (commercially available as Kane Ace MX 135), a core-shell styrene-butadiene rubber dispersion (25% core-shell rubber by weight) in D.E.N.™-438 phenolic novolac epoxy (commercially available as Kane Ace MX 215), a core-shell styrene-butadiene rubber dispersed in bisphenol A epoxy resin (such as KDAD-7101 35% core shell rubber by weight) (commercially available from Kukdo Chemical), a core-shell styrene-butadiene rubber dispersion (25% core-shell rubber by weight) in Araldite® MY-721 multi-functional epoxy (commercially available as Kane Ace MX 416), a core-shell styrene-butadiene rubber dispersion (25% core-shell rubber by weight) in MY-0510 multi-functional epoxy (commercially available as Kane Ace MX 451), a core-shell styrene-butadiene rubber dispersion (25% core-shell rubber by weight) in Syna Epoxy 21 Cyclo-aliphatic Epoxy from Synasia (commercially available as Kane Ace MX 551), and a core-shell styrene-butadiene rubber dispersion (25% core-shell rubber by weight) in polypropylene glycol (MW 400) (commercially available as Kane Ace MX 715), each available from Kancka Texas Corporation.

Exemplary non-limiting commercial core-shell elastomeric particle products using polysiloxane rubber particles that may be utilized in the coating composition of the present disclosure include a core-shell polysiloxane rubber powder (commercially available as GENIOPERL® P52 from Wacker), a core-shell polysiloxane rubber dispersion (40% core-shell rubber by weight) in bisphenol A diglycidyl ether (commercially available as ALBIDUR® EP2240A from Evonick), a core-shell polysiloxane rubber dispersion (25% core-shell rubber by weight) in Epon 828 (commercially available as Kane Ace MX 960), a core-shell polysiloxane rubber dispersion (25% core-shell rubber by weight) in Epon® 863 (commercially available as Kane Ace MX 965) each available from Kaneka Texas Corporation.

The composition may comprise the elastomeric particles, if present at all, in an amount of at least 5 percent by weight based on the total weight of the composition. The composition may comprise the elastomeric particles in an amount of no more than 25 percent by weight based on the total composition weight, such as no more than 20 percent by weight. The composition may comprise the elastomeric particles in an amount of up to percent by weight to 25 percent by weight based on the total composition weight, such as 5 percent by weight to 20 percent by weight.

### Auxiliary Toughening Agent

The composition may further comprise an auxiliary toughening agent. As used herein “auxiliary toughening agent” refers to materials that do not have a core/shell structure and have a Tg of −150° C. and less than 30° C., calculated, for example, using the Fox Equation or measured, for example, using differential scanning calorimetry.

The auxiliary toughening may be in the first component, the second component, a third or higher component or combinations thereof.

The auxiliary toughening agent may comprise organic or inorganic material and may comprise particles of a single type of toughening agent or may comprise particles of two or more types of toughening agent. That is, the auxiliary toughening agent may comprise particles of a first auxiliary toughening agent and may further comprise particles of at least a second (i.e., a second, a third, a fourth, etc.) auxiliary toughening agent that is different from the first auxiliary toughening agent. As used herein with respect to types of auxiliary toughening agent utilized in the compositions disclosed herein, reference to “first”, “second”, etc. is for convenience only and does not refer to order of addition to the composition or the components comprising the composition.

Suitable toughening agents for use in the compositions disclosed herein include oligomeric or polymeric auxiliary toughening agents such as those formed from elastomers, branched polymers, rubbery polymers, rubbery copolymers, block copolymers, or combinations thereof.

The auxiliary toughening agent may comprise a reactive functional group, such as a reactive functional group capable of reacting with an epoxide functional group or an amine functional group. Suitable examples of functional groups include an epoxide functional group, an acrylate functional group, an acetoacetyl functional group, a ketone/aldehyde functional group, an isocyanate functional group, an amine functional group, a thiol functional group, or combinations thereof.

For example, auxiliary toughening agents may comprise a carboxyl-terminated butadiene-acrylonitrile (CTBN) copolymer, an amine-terminated butadiene-acrylonitrile copolymer, an epoxy-terminated butadiene-acrylonitrile copolymer, an epoxy-functional polyester, an acrylate-functional polyester, an epoxide-functional polyurethane, an acrylate-functional polyurethane, an amine-functional polyether, epoxide-, amino- or acrylate-functional low Tg polymers or combinations thereof.

The auxiliary toughening agent may comprise an epoxy-adduct and/or an amine-adduct. The composition may comprise one or more epoxy-adducts and/or amine-adducts. As used herein, the term “epoxy-adduct,” when used with respect to the auxiliary toughening agent, refers to a reaction product comprising the residue of an epoxy and another compound that does not include an epoxide functional group. For example, the auxiliary toughening agent may comprise a reaction product of reactants comprising a CTBN and an epoxide-functional compound such that the reaction product comprises an epoxy-terminated rubber. The term “epoxy-adduct” used with respect to the auxiliary toughening agent is different than the epoxy-containing compound (E2) described above to form the amine-functional aliphatic etheramine-epoxy adduct (A1). The epoxy used to form the epoxy-adduct may comprise any of the polymeric epoxy-containing compounds listed above that may be included in the composition and/or any of the monomeric epoxy-containing compounds listed below that may be included in the composition. As used herein, the term “amine-adduct,” when used with respect to the auxiliary toughening agent, refers to a reaction product comprising the residue of an amine and another compound that does not include an amino functional group. For example, the auxiliary toughening agent may comprise a reaction product of reactants comprising a butadiene-acrylonitrile copolymer and an amino-functional compound such that the reaction product comprises an amine-terminated butadiene-acrylonitrile copolymer. Useful auxiliary toughening agents include HYPRO (available from Huntsman Corporation), ALBIPOX (available from Evonik), and STRUKTOL (available from Schill and Seilacher).

The auxiliary toughening agent may comprise an epoxy-adduct comprising the reaction product of reactants comprising an epoxy, a polyol, and an anhydride. The polyol used to form the epoxy-adduct may include diols, triols, tetraols and higher functional polyols. Combinations of such polyols may also be used. The polyols may be based on a polyether chain derived from ethylene glycol, propylene glycol, butylene glycol, hexylene glycol and the like as well as mixtures thereof. The polyol may also be based on a polyester chain derived from ring opening polymerization of caprolactone (referred to as polycaprolactone-based polyols hereinafter). Suitable polyols may also include polyether polyols, polyurethane polyols, polyurea polyols, acrylic polyols, polyester polyols, polybutadiene polyols, hydrogenated polybutadiene polyols, polycarbonate polyols, polysiloxane polyols, and combinations thereof. Polyamines corresponding to polyols may also be used, and in this case, amides instead of carboxylic esters will be formed with the anhydrides.

The polyol may comprise a polycaprolactone-based polyol. The polycaprolactone-based polyols may comprise diols, triols or tetraols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101.

The polyol may comprise a polytetrahydrofuran-based polyol. The polytetrahydrofuran-based polyols may comprise diols, triols or tetraols terminated with primary hydroxyl groups. Commercially available polytetrahydrofuran-based polyols include those sold under the trade name Terathane®, such as Terathane® PTMEG 250 and Terathane® PTMEG 650 which are blends of linear diols in which the hydroxyl groups are separated by repeating tetramethylene ether groups, available from Invista. In addition, polyols based on dimer diols sold under the trade names Pripol®, Solvermol™ and Empol®, available from Cognis Corporation, or bio-based polyols, such as the tetrafunctional polyol Agrol 4.0, available from BioBased Technologies, may also be utilized.

The anhydride that may be used to form the epoxy-adduct may comprise any suitable acid anhydride known in the art. For example, the anhydride may comprise hexahydrophthalic anhydride and its derivatives (e.g., methyl hexahydrophthalic anhydride); phthalic anhydride and its derivatives (e.g., methyl phthalic anhydride); maleic anhydride; succinic anhydride; trimelletic anhydride; pyromelletic dianhydride (PMDA); 3,3′,4,4′-oxydiphthalic dianhydride (ODPA); 3,3′,4,4′-benzophenone tetracarboxylic dianhydride (BTDA); and 4,4′-diphthalic (hexafluoroisopropylidene) anhydride (6FDA).

The epoxy-adduct may comprise a diol, a monoanhydride, and a diepoxy compound, wherein the mole ratio of diol, monoanhydride, and diepoxy compounds in the epoxy-adduct may vary from 0.5:0.8:1.0 to 0.5:1.0:6.0.

The epoxy-adduct may comprise a triol, a monoanhydride, and a diepoxy compound, wherein the mole ratio of triol, monoanhydride, and diepoxy compounds in the epoxy-adduct may vary from 0.5:0.8:1.0 to 0.5:1.0:6.0.

The epoxy-adduct may comprise a tetraol, a monoanhydride, and a diepoxy compound, wherein the mole ratio of tetraol, monoanhydride, and diepoxy compounds in the epoxy-adduct may vary from 0.5:0.8:1.0 to 0.5:1.0:6.0.

Other suitable epoxy-containing compounds (E1) include epoxy-adducts such as epoxy polyesters formed as the reaction product of reactants comprising an epoxy-containing compound, a polyol and an anhydride, as described in U.S. Pat. No. 8,796,361, col. 3, line 42 through col. 4, line 65, the cited portion of which is incorporated herein by reference.

In examples, the epoxy-functional urethane may comprise a reaction product of reactants comprising an isocyanate-functional prepolymer and an epoxide-functional compound. In examples, the acrylate-functional urethane may comprise a reaction product of reactants comprising an isocyanate functional prepolymer and a hydroxyl-containing acrylate such as hydroxyethyl acrylate. The epoxy- or acrylate-functional low Tg polymers may include functional acrylics, functional polyolefin rubbers, functional polydiene rubbers, functional siloxanes, and the like. Suitable examples of such auxiliary toughening agents include Miramer acrylate-functional urethane and polyester resins available from Miwon Specialty Chemical Co. or Sartomer acrylate-functional resins available from Sartomer. Additional examples include Ancarez 2364, an acrylate-functional urethane toughener in bisphenol A epoxy resin available from Evonik.

The auxiliary toughening agent may comprise a functional group equivalent weight of at least 150 g/eq, such as at least 200 g/eq, such as at least 300 g/eq, such as at least 400 g/eq. The auxiliary toughening agent may comprise a functional group equivalent weight of no more than 2000 g/eq, such as no more than 1000 g/eq, such as no more than 800 g/eq, such as no more than 250 g/eq. The auxiliary toughening agent may comprise an epoxide equivalent weight of 150 g/eq to 2000 g/eq, such as 150 g/eq to 1000 g/eq, such as 150 g/eq to 250 g/eq, such as 200 g/eq to 250 g/eq, such as 300 g/eq to 2000 g/eq, such as 300 g/eq to 1000 g/eq, such as 400 g/eq to 800 g/eq. As used herein, the term “functional group equivalent weight” means the equivalent weight based on a functional group, such as an epoxide functional group, an acrylate functional group, an acetoacetyl functional group, a ketone/aldehyde functional group, an isocyanate functional group, an amino functional group, a thiol functional group, or combinations thereof.

In suitable examples, the auxiliary toughening agent may comprise an epoxide equivalent weight of at least 150 g/eq, such as at least 200 g/eq, such as at least 300 g/eq, such as at least 400 g/eq. The auxiliary toughening agent may comprise an epoxide equivalent weight of no more than 2000 g/eq, such as no more than 1000 g/eq, such as no more than 800 g/eq, such as no more than 250 g/eq. The auxiliary toughening agent may comprise an epoxide equivalent weight of 150 g/eq to 2000 g/eq, such as 150 g/eq to 1000 g/eq, such as 150 g/eq to 250 g/eq, such as 200 g/eq to 250 g/eq, such as 300 g/eq to 2000 g/eq, such as 300 g/eq to 1000 g/eq, such as 400 g/eq to 800 g/eq.

In suitable examples, the auxiliary toughening agent may comprise an amine hydrogen equivalent weight of at least 150 g/eq, such as at least 200 g/eq, such as at least 300 g/eq, such as at least 400 g/eq. The auxiliary toughening agent may comprise an amine hydrogen equivalent weight of no more than 2000 g/eq, such as no more than 1000 g/eq, such as no more than 800 g/eq, such as no more than 250 g/eq. The auxiliary toughening agent may comprise an amine hydrogen equivalent weight of 150 g/eq to 2000 g/eq, such as 150 g/eq to 1000 g/eq, such as 150 g/eq to 250 g/eq, such as 200 g/eq to 250 g/eq, such as 300 g/eq to 2000 g/eq, such as 300 g/eq to 1000 g/eq, such as 400 g/eq to 800 g/eq.

The composition may comprise the auxiliary toughening agent in an amount of at least 1 percent by weight based on total weight of the composition, such as at least 2 percent by weight, such as at least 5 percent by weight. The composition may comprise the auxiliary toughening agent in an amount of no more than 25 percent by weight based on total weight of the composition, such as no more than 15 percent by weight. The composition may comprise the auxiliary toughening agent in an amount of 1 percent by weight to 25 percent by weight based on total weight of the composition, such as 1 percent by weight to 15 percent by weight, such as 2 percent by weight to 25 percent by weight, such as 5 percent by weight to 15 percent by weight.

### Reinforcing Fillers

Optionally, the composition may further comprise a reinforcement filler. The reinforcing filler may be present in first component, the second component, a third or higher component or combinations thereof. The composition may comprise particles of a single type of reinforcement filler or may comprise particles of two or more types of reinforcement filler. That is, the reinforcement filler may comprise particles of a first reinforcement filler and may further comprise particles of at least a second (i.e., a second, a third, a fourth, etc.) reinforcement filler that is different from the first reinforcement filler. As used herein with respect to types of reinforcement filler utilized in the compositions disclosed herein, reference to “first”, “second”, etc. is for convenience only and does not refer to order of addition to the composition or the components comprising the composition.

Useful reinforcement fillers that may be introduced to the adhesive composition to provide improved mechanical properties include fibrous materials such as fiberglass, fibrous titanium dioxide, whisker type calcium carbonate (aragonite), carbon fiber (which includes graphite and carbon nanotubes), basalt fibers, and ceramic fibers. Additional reinforcement fillers include those with a plate-like or needle-like morphology, including, but not limited to, wollastonite (calcium inosilicate), talc (hydrated magnesium silicate), mica, micaceous iron oxides, glass flake, aluminum flakes, and boron nitride. Additional reinforcement fillers include those with spherical or irregular morphologies, such as titanium dioxide, spherical aluminum, or calcium carbonate.

The reinforcement filler may comprise an average particle size in the largest dimension of at least 5 microns, such as at least 8 microns, such as at least 10 microns. The reinforcement filler may comprise an average particle size in the largest dimension of no more than 1000 microns, such as no more than 500 microns, such as no more than 100 microns. The reinforcement filler may comprise an average particle size in the largest dimension of 5 microns to 1000 microns, such as 8 microns to 500 microns, such as 10 microns to 100 microns. Particle size may be measured, for example, using dynamic light scattering (DLS), such as using a Malvern Autosizer Lo-C or an equivalent instrument, or a scanning electron microscope (SEM), such as a Quanta 250 FEG SEM or an equivalent instrument.

If utilized at all, the composition may comprise such reinforcement fillers in an amount of at least 2.5 percent by weight based on total weight of the composition, such as at least 5 percent by weight. If utilized at all, the composition may comprise such reinforcement fillers in an amount of no more than 30 percent by weight based on total weight of the composition, such as no more than 25 percent by weight, such as no more than 20 percent by weight. If utilized at all, the composition may comprise such reinforcement fillers in an amount of up to 30 percent by weight based on total weight of the composition, such as 2.5 percent by weight to 25 percent by weight, such as 5 percent by weight to 20 percent by weight.

### Accelerators

Optionally, the composition may comprise an accelerator. The second component and/or a third or higher component may comprise the accelerator.

The second component may comprise an accelerator. In examples, the accelerator may comprise, or consist essentially of, or consist of, a guanidine. It will be understood that “guanidine,” as used herein, refers to guanidine and derivatives thereof. For example, the curing agent that may be used includes guanidines, substituted guanidines, substituted ureas, melamine resins, guanamine derivatives, and/or mixtures thereof. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, more especially, cyanoguanidine (dicyandiamide, e.g., Dyhard® available from AlzChem). Representatives of suitable guanamine derivatives which may be mentioned are alkylated benzoguanamine resins, benzoguanamine resins or methoxymethylethoxymethylbenzoguanamine.

For example, the guanidine may comprise a compound, moiety, and/or residue having the following general structure:

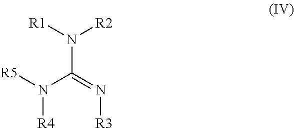

wherein each of R1, R2, R3, R4, and R5 (i.e., substituents of structure (IV)) comprise hydrogen, (cyclo)alkyl, aryl, aromatic, organometallic, a polymeric structure, or together can form a cycloalkyl, aryl, or an aromatic structure, and wherein R1, R2, R3, R4, and R5 may be the same or different. As used herein, “(cyclo)alkyl” refers to both alkyl and cycloalkyl. When any of the R groups “together can form a (cyclo)alkyl, aryl, and/or aromatic group”, it is meant that any two adjacent R groups are connected to form a cyclic moiety, such as the rings in structures (V)-(VIII) below.

It will be appreciated that the double bond between the carbon atom and the nitrogen atom that is depicted in structure (IV) may be located between the carbon atom and another nitrogen atom of structure (IV). Accordingly, the various substituents of structure (IV) may be attached to different nitrogen atoms depending on where the double bond is located within the structure.

The guanidine may comprise a cyclic guanidine such as a guanidine of structure (IV) wherein two or more R groups of structure (IV) together form one or more rings. In other words, the cyclic guanidine may comprise ≥1 ring(s). For example, the cyclic guanidine may either be a monocyclic guanidine (1 ring) such as depicted in structures (V) and (VI) below, or the cyclic guanidine may be bicyclic or polycyclic guanidine (≥2 rings) such as depicted in structures (VII) and (VIII) below.

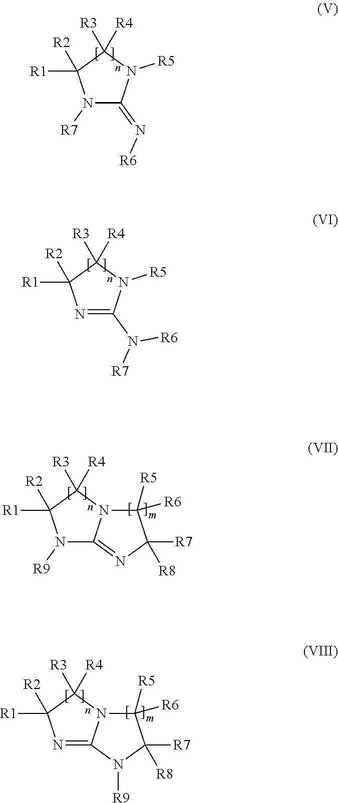

Each substituent of structures (V) and/or (VI), R1-R7, may comprise hydrogen, (cyclo)alkyl, aryl, aromatic, organometallic, a polymeric structure, or together can form a cycloalkyl, aryl, or an aromatic structure, and wherein R1-R7 may be the same or different. Similarly, each substituent of structures (VII) and (VIII), R1-R9, may be hydrogen, alkyl, aryl, aromatic, organometallic, a polymeric structure, or together can form a cycloalkyl, aryl, or an aromatic structure, and wherein R1-R9 may be the same or different. Moreover, in some examples of structures (V) and/or (VI), certain combinations of R1-R7 may be part of the same ring structure. For example, R1 and R7 of structure (V) may form part of a single ring structure. Moreover, it will be understood that any combination of substituents (R1-R7 of structures (V) and/or (VI) as well as R1-R9 of structures (VII) and/or (VIII)) may be chosen so long as the substituents do not substantially interfere with the catalytic activity of the cyclic guanidine.

Each ring in the cyclic guanidine may be comprised of ≥5 members. For example, the cyclic guanidine may comprise a 5-member ring, a 6-member ring, and/or a 7-member ring. As used herein, the term “member” refers to an atom located in a ring structure. Accordingly, a 5-member ring will have 5 atoms in the ring structure (“n” and/or “m”=1 in structures (V)-(VIII)), a 6-member ring will have 6 atoms in the ring structure (“n” and/or “m”=2 in structures (V)-(VIII)), and a 7-member ring will have 7 atoms in the ring structure (“n” and/or “m”=3 in structures (V)-(VIII)). It will be appreciated that if the cyclic guanidine is comprised of ≥2 rings (e.g., structures (VII) and (VIII)), the number of members in each ring of the cyclic guanidine can either be the same or different. For example, one ring may be a 5-member ring while the other ring may be a 6-member ring. If the cyclic guanidine is comprised of ≥3 rings, then in addition to the combinations cited in the preceding sentence, the number of members in a first ring of the cyclic guanidine may be different from the number of members in any other ring of the cyclic guanidine.

It will also be understood that the nitrogen atoms of structures (V)-(VIII) may further have additional atoms attached thereto. Moreover, the cyclic guanidine may either be substituted or unsubstituted. For example, as used herein in conjunction with the cyclic guanidine, the term “substituted” refers to a cyclic guanidine wherein R5, R6, and/or R7 of structures (V) and/or (VI) and/or R9 of structures (VII) and/or (VIII) is not hydrogen. As used herein in conjunction with the cyclic guanidine, the term “unsubstituted” refers to a cyclic guanidine wherein R1-R7 of structures (V) and/or (VI) and/or R1-R9 of structures (VII) and/or (VIII) are hydrogen.

The cyclic guanidine may comprise a bicyclic guanidine, and the bicyclic guanidine may comprise 1,5,7-triazabicyclo[4.4.0]dec-5-ene (“TBD” or “BCG”) or 7-methyl-1,5,7-triazabicyclo[4.4.0]dec-5-ene (MTBD).

Other useful accelerators may comprise amidoamine or polyamide accelerators, such as, for example, one of the Ancamide® products available from Air Products, amine, amino-containing phenols, dihydrazide, imidazole, or dicyandiamide adducts and complexes, such as, for example, one of the Ajicure® products available from Ajinomoto Fine Techno Company, 3,4-dichlorophcnyl-N,N-dimcthylurca (A.K.A. Diuron) available from Alz Chem, or combinations thereof.

The accelerator may comprise a tertiary amine. For example, the accelerator may include tertiary amines, cyclic tertiary amines, or secondary amines that react with an epoxide group of an epoxy-containing compound at room temperature to form a tertiary amine, or secondary amines that react with a thiol group of a polythiol to form a thiolate ion that may further react with an epoxide group of an epoxy-containing compound to form a tertiary amine. The accelerator may comprise an alkanolamine. As used herein, the term “alkanolamine” refers to a compound comprising a nitrogen atom bonded to an alkanol substituent comprising an alkyl group comprising a primary, secondary or tertiary hydroxyl group. The alkanolamine may have the general structure R¹ₙN(R²—OH)₃₋ₙ, wherein R¹ comprises hydrogen or an alkyl group, R2 comprises an alkanediyl group, and n=0, 1 or 2. When n=2, two R¹ groups will be present, and these groups may be the same or different. When n=0 or 1, 2 or 3 R²—OH groups will be present, and these groups may be the same or different. The alkyl groups comprise aliphatic linear or branched carbon chains that may be unsubstituted or substituted with, for example, ether groups. Suitable alkanolamines include monoalkanolamines such as ethanolamine, N-methylethanolamine, 1-amino-2-propanol, and the like, dialkanolamines such as diethanolamine, diisopropanolamine, and the like, and trialkanolamines such as trimethanolamine, triethanolamine, tripropanolamine, tributanolamine, tripentanolamine, trihexanolamine, triisopropanolamine, and the like. As examples, the cyclic tertiary amine may comprise 1,4-diazabicyclo[2.2.2]octane (“DABCO”), 1,8-diazabicylo[5.4.0]undec-7-ene (“DBU”), 1,5-diazabicyclo[4.3.0]non-5-ene (“DBN”), 1,5,7-triazabicyclo[4.4.0]dec-5-ene (“TBD”), and combinations thereof.

Additional examples of suitable accelerators include, a pyridine, an imidazole, a phenol, a pyrazole, or combinations thereof. Suitable examples include dimethylaminopyridine, 1-methylimidazole, N,N′-carbonyldiimidazole, [2,2]bipyridine, 2,4,6-tris(dimethylamino methyl)phenol, 3,5-dimethylpyrazole, and combinations thereof. Additional examples of useful accelerators include Mannich bases, tetraalkyl ammonium salts, metal salts, and strong bases.

The accelerator, if present at all, may be present in an amount of at least 0.1 percent by weight based on total weight of the second component. The accelerator may be present in an amount of no more than 10 percent by weight based on total weight of the second component, such as no more than 5 percent by weight. The accelerator, if present at all, may be present in an amount of up to 10 percent by weight based on total weight of the second component, such as 0.1 percent by weight to 5 percent by weight.

### Additives

The composition may optionally comprise an additive. As used herein, an “additive” refers to a rheology modifier, a tackifier, a surface-active agent, a wetting agent, a flame retardant, a corrosion inhibitor, a UV stabilizer, a colorant, a tint, a solvent, a plasticizer, an adhesion promoter, an antioxidant, a defoamer, a rust inhibitor, a silane, a silane terminated polymer, a silyl terminated polymer, and/or a moisture scavenger.

Rheology modifiers optionally may include thixotropes. Thixotropes may be sag control agents. Useful thixotropes and/or sag control agents that may be used include wax, fumed silica, castor wax, clay, organo clay, fibers such as Aramid® fibers and Kevlar® fibers, ceramic fibers, and/or engineered cellulose fibers. Waxes useful in the compositions disclosed herein are not particularly limited provided the wax has properties suitable for thixotropy and/or sag control. Generally, the wax may have a weight-average molecular weight of less than 10,000. Examples of suitable waxes useful in the compositions disclosed herein include microcrystalline waxes, polyethylene waxes, Fischer-Tropsch waxes, paraffin waxes, Castor wax, polypropylene waxes, amide derivatives of the former, or combinations thereof. Further examples of suitable thixotropes and/or sag control agents include organic resins or solids comprising chemical linkages with hydrogen bonding capability, such as polyurethane, polyurea, polyester, polyaramid, polyimide, carbodiimide, and combinations thereof. Such polyureas may include those disclosed in U.S. Pat. No. 4,965,317 at col. 5, line 10 to col. 6, line 24, incorporated herein by reference. The organic resins or solids may optionally comprise reactive functional groups such as epoxide, isocyanate, or ethylenic unsaturation. Combinations of thixotropes may be used to achieve sag control.

Examples of suitable wetting agents include those under the commercial name BYK®, DISPERBYK®, DOWSIL™, TEGO® Wet, and TERGITOL™.

Examples of suitable corrosion inhibitors include, for example, zinc phosphate-based corrosion inhibitors, for example, micronized Halox® SZP-391, Halox® 430 calcium phosphate, Halox® ZP zinc phosphate, Halox® SW-111 strontium phosphosilicate, Halox® 720 mixed metal phosphor-carbonate, and Halox® 550 and 650 proprietary organic corrosion inhibitors commercially available from Halox. Other suitable corrosion inhibitors include Heucophos® ZPA zinc aluminum phosphate and Heucophos® ZMP zinc molybdenum phosphate, commercially available from Heucotech Ltd.

A corrosion inhibitor can comprise a lithium silicate such as lithium orthosilicate (Li₄SiO₄) and lithium metasilicate (Li₂SiO₃), MgO, an azole, or a combination of any of the foregoing. The corrosion inhibiting component may further comprise magnesium oxide (MgO) and/or an azole.

Useful colorants or tints may include phthalocyanine blue and ultramarine blue.

Compositions provided by the present disclosure can comprise a flame retardant or combination of flame retardants. Certain thermally conductive materials such as aluminum hydroxide and magnesium hydroxide, for example, also may be flame retardants. As used herein, “flame retardant” refers to a material that slows down or stops the spread of fire or reduces its intensity. Flame retardants may be available as a powder that may be mixed with a composition, a foam, or a gel. In examples, when the compositions disclosed herein include a flame retardant, such compositions may form a coating on a substrate surface and such coating may function as a flame retardant.

As set forth in more detail below, a flame retardant can include a mineral, an organic compound, an organohalogen compound, an organophosphorous compound, or a combination thereof.

Suitable examples of minerals include huntite, hydromagnesite, various hydrates, red phosphorous, boron compounds such as borates, carbonates such as calcium carbonate and magnesium carbonate, and combinations thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anhydride, tetrabromobisphenol A (TBBPA) and hexabromocyclododecane (HBCD). Such halogenated flame retardants may be used in conjunction with a synergist to enhance their efficiency. Other suitable examples include antimony trioxide, antimony pentaoxide, and sodium antimonate.

Suitable examples of organophosphorous compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Suitable examples of organic compounds include carboxylic acid, dicarboxylic acid, melamine, and organonitrogen compounds.

Other suitable flame retardants include ammonium polyphosphate and barium sulfate.

Suitable solvents include toluene, methyl ethyl ketone, benzene, n-hexane, xylene, and combinations thereof.

Useful plasticizers that may be used include polymers, trimellitates, sebacates, esters, phthalates, citrates, adipates, benzoates, and the like. Non-limiting examples of such plasticizers include diisononylphthalate (Jayflex™ DINP available from Exxon Mobil), dioctylphthalate (Cereplas DOA™ available from Valtris), diisodecylphthalate (Jayflex™ DIDP available from Exxon Mobil), and alkyl benzyl phthalate (Santicizer 278 available from Valtris); benzoate-based plasticizers such as dipropylene glycol dibenzoate (K-Flex® available from Emerald Performance Materials); and other plasticizers including terephthalate-based dioctyl terephthalate (DEHT available from Eastman Chemical Company), alkylsulfonic acid ester of phenol (Mesamoll available from Borchers), epoxidized soybean oil (Plaschek 775 from Valtris), citric acid esters (Citroflex available from Morflex), phenylphophates (Santicizer 148 from Solutia), and 1,2-cyclohexane dicarboxylic acid diisononyl ester (Hexamoll DINCH available from BASF).

Stabilizers may be blended to prevent reduction of molecular weight by heating, gelation, coloration, generation of an odor and the like. Stabilizers that may be used in the compositions disclosed herein are not particularly limited. Examples of stabilizers useful in the compositions disclosed herein include an antioxidant, an ultraviolet absorbing agent, or combinations thereof. The stabilizer optionally may be lactone-based. The antioxidant may be used to prevent oxidative degradation of the disclosed compositions. Examples of the antioxidant include phenol-based antioxidants, sulfur-based antioxidants, and phosphorus-based antioxidants. The ultraviolet absorbing agent may be used to improve the light resistance of the disclosed compositions. Examples of the ultraviolet absorbing agent include benzotriazole-based ultraviolet absorbing agents and benzophenone-based ultraviolet absorbing agents. Specific examples of suitable stabilizers include SUMILIZER GM (trade name), SUMILIZER TPD (trade name) and SUMILIZER TPS (trade name) manufactured by Sumitomo Chemical Co., Ltd., IRGANOX 1010 (trade name), IRGANOX HP2225FF (trade name), IRGAFOS 168 (trade name), IRGANOX 1520 (trade name) and TINUVIN P manufactured by Ciba Specialty Chemicals, JF77 (trade name) manufactured by Johoku Chemical Co., Ltd., TOMINOX TT (trade name) manufactured by API Corporation and AO-4125 (trade name) manufactured by ADEKA CORPORATION.

The composition may also comprise a silane terminated polymer. The silane terminated polymer may be capable of crosslinking in the presence of moisture. The polymer may be an alkoxysilane-terminated polyether, an alkoxysilane-terminated polyurethane, or combinations thereof. The alkoxysilane can be methoxy or ethoxy silane, with one, two, or three alkoxy groups per silane. Commercial examples of alkoxysilane-terminated polymers include the Kaneka MS polymers such as SAX 350, SAX 400, and SAX 750 or the Wacker STP-E series such as STP-E30.

Suitable moisture scavengers include vinyltrimethoxysilane (Silquest A-171 from Momentive), vinyltriethoxysilane (Silquest A-151NT from Momentive), gamma-methacryloxypropyltrimethoxysilane (Silquest A-174NT available from Evonik), molecular sieves, calcium oxide (POLYCAL OS325 available from Mississippi Lime), or combinations thereof.

The composition optionally may further comprise a dispersant. As used herein, the term “dispersant” refers to a substance that may be added to the composition in order to improve the separation of filler particles by wetting the particles and breaking apart agglomerates. Suitable dispersants for use in the composition include fatty acid, phosphoric acid esters, polyurethanes, polyamines, polyacrylates, polyalkoxylates, sulfonates, polyethers, and polyesters, or any combination thereof. Non-limiting examples of commercially available dispersants include ANTI-TERRA-U100, DISPERBYK-102, DISPERBYK-103, DISPERBYK-111, DTSPERBYK-171, DTSPERBYK-2151, DISPERBYK-2059, DTSPERBYK-2000, DISPERBYK-2117, and DISPERBYK-2118 available from BYK Company; and SOLSPERSE 24000SC, SOLSPERSE 16000 and SOLSPERSE 8000 hyperdispersants available from The Lubrizol Corporation.

Additives, if present at all, may be present in the composition in a combined amount of at least 0.01 percent by weight based on total weight of the composition, such as at least 0.05 percent by weight. Additives, if present at all, may be present in a combined amount of no more than 15 percent by weight based on total weight of the composition, such as no more than 3 percent by weight. Such additives, if present at all, may be present in the composition in a combined amount of 0.01 percent by weight to 12 percent by weight based on total weight of the composition, such as 0.05 percent by weight to 10 percent by weight.

### Compositions, Systems and Methods

The 2K compositions disclosed herein may comprise, or may consist essentially of, or may consist of: a first component comprising, or consisting essentially of, or consisting of, an epoxy-containing compound (E1); a second component comprising, or consisting essentially of, or consisting of, an amine-functional aliphatic etheramine-epoxy adduct (A1); elastomeric particles; and auxiliary toughening agent; and optionally a reinforcing filler, an accelerator, an additive, or combinations thereof; wherein the elastomeric particles, auxiliary toughening agent, reinforcing filler, accelerator and additive each may be in the first component and/or the second component.

The 3K compositions disclosed herein may comprise, or may consist essentially of, or may consist of: a first component comprising, or consisting essentially of, or consisting of, an epoxy-containing compound (E1); a second component comprising, or consisting essentially of, or consisting of, an amine-functional aliphatic etheramine-epoxy adduct (A1); elastomeric particles; and auxiliary toughening agent; and optionally a reinforcing filler, an accelerator, an additive, or combinations thereof; wherein the elastomeric particles, auxiliary toughening agent, reinforcing filler, accelerator and additive each may be in the first component, the second component and/or a third component.

The composition may comprise the first component in an amount of at least 10 percent by weight based on total weight of the composition, such as at least 30 percent by weight. The composition may comprise the second component in an amount of no more than 90 percent by weight based on total weight of the composition, such as no more than 70 percent by weight. The composition may comprise the first component in an amount of 10 percent by weight to 90 percent by weight based on total weight of the composition, such as 30 percent by weight to 70 percent by weight.

The composition may comprise the second component in an amount of at least 10 percent by weight based on total weight of the composition, such as at least 30 percent by weight. The composition may comprise the second component in an amount of no more than 90 percent by weight based on total weight of the composition, such as no more than 70 percent by weight. The composition may comprise the second component in an amount of 10 percent by weight to 90 percent by weight based on total weight of the composition, such as 30 percent by weight to 70 percent by weight.

The compositions disclosed herein may be an adhesive composition, a pottant composition, a gap filler composition, a pre-preg composition, a liquid shim composition, or combinations thereof. That is, the compositions disclosed herein may form coatings. Such coatings may be an adhesive, a pottant, a gap filler, a liquid shim, a composite formed from a pre-preg, or combinations thereof.

The components of the composition may be combined and frozen and stored (“pre-mixed frozen” or “PMF”) and may be thawed and cured by exposure to ambient conditions and optionally also by external factors, such as temperature, to form a coating. In examples, the PMF may be stored at temperatures of −100° C. to −25° C., such as −100° C. to −15° C., to retard curing, such as at a minimum of −75° C. to −40° C.

It has been surprisingly discovered that coatings formed from the compositions disclosed herein exhibit the combination of improved structural adhesive performance and improved wedge impact peel resistance under both ambient and −40° C. conditions compared to adhesives formed from compositions that do not include this combination of materials, which do not show improvement in all three of these parameters. The coatings formed from the compositions disclosed herein surprisingly exhibit:
(a) a lap shear strength of at least 25 MPa measured according to ASTM D1002-10 using 2024-T3 aluminum substrate of 1.6 mm thickness using an INSTRON 5567 machine in tensile mode with a pull rate of 1.3 mm per minute, such as at least 26 MPa, such as at least such as at least 27 MPa, such as at least 28 MPa, such as at least 29 MPa, such as at least 30 MPa, such as at least 31 MPa, such as at least 32 MPa, such as at least 33 MPa, such as at least 34 MPa, such as at least 36 MPa;
(b) a wedge impact peel resistance at ambient temperature of at least 10 N/mm tested according to ISO 11343 Dynamic Resistance to Cleavage testing using 5754 aluminum of 1.2 mm thickness using an INSTRON CEAST 9350 drop tower model at an impact speed of 2 m/sec, such as at least 12 N/mm, such as at least 14 N/mm, such as at least 16 N/mm, such as at least 18 N/mm, such as at least 20 N/mm, such as at least 22 N/mm, such as at least 24 N/mm, such as at least 26 N/mm, such as at least 28 N/mm, such as at least 30 N/mm, such as at least 32 N/mm, such as at least 34 N/mm; and
(c) a wedge impact peel resistance at −40° C. of at least 3.0 N/mm, wherein wedge impact peel resistance at both ambient and −40° C. tested according to ISO 11343 Dynamic Resistance to Cleavage testing using 5754 aluminum of 1.2 mm thickness using an INSTRON CEAST 9350 drop tower model at an impact speed of 2 m/sec, with samples being conditioned at −40° C. for at least 30 minutes before testing, such as at least 5 N/mm, such as at least 6 N/mm, such as at least 8 N/mm, such as at least 10 N/mm, such as at least 12 N/mm, such as at least 14 N/mm, such as at least 16 N/mm, such as at least 18 N/mm, such as at least 20 N/mm, such as at least 22 N/mm, such as at least 24 N/mm, such as at least 26 N/mm, such as at least 28 N/mm, such as at least 30 N/mm, such as at least 32 N/mm.

Also disclosed herein are methods for preparing one of the compositions disclosed above. The method optionally may comprise mixing the first and second components and optionally the third or higher component at a temperature of less than 50° C., such as 0° C. to 50° C., such as 15° C. to 35° C., such as at ambient temperature.

The composition described above may be applied alone or as part of a system that can be deposited in a number of different ways onto a number of different substrates. The compositions disclosed herein may be applied to a cleaned or uncleaned substrate surface (including oily or oiled). The compositions disclosed herein also may be applied to a substrate surface that also is pretreated and/or coated with an additional coating such as an electrocoat, a primer, a basecoat and/or a topcoat. Accordingly, disclosed herein are methods for applying the composition to a substrate comprising, or consisting essentially of, or consisting of, applying one of the compositions described hereinabove to at least a portion of a surface of the substrate. That is, the composition can be applied to the surface of a substrate in any number of different ways, non-limiting examples of which include brushes, rollers, trowels, spatulas, dips, spray guns and applicator guns to form a coating on at least a portion of the substrate surface.

After application to the substrate(s), the composition may be cured to form a coating on the substrate surface. For example, the composition may be allowed to cure at room temperature or slightly thermal conditions for any desired time period (e.g., from 30 minutes to many weeks, such as at least 1 week, such as at least 2 weeks, such as at least 3 weeks) sufficient to cure the composition on the substrate(s). Optionally, the composition then may be cured by baking and/or curing at elevated temperature, such as at a temperature of 180° C. or below, such as 130° C. or below, such as 110° C. or below, such as 100° C. or below, such as 90° C. or below, such as 80° C. or below, such as 70° C. or below, but greater than ambient, such as greater than 40° C., such as greater than 50° C., and for any desired time period (e.g., from 5 minutes to 1 hour).

Also disclosed are methods for forming a bond between two substrates for a wide variety of potential applications in which the bond between the substrates provides particular mechanical properties related to lap shear strength. The method may comprise, or consist essentially of, or consist of, applying the composition described above to a first substrate; contacting a second substrate to the composition such that the composition is located between the first substrate and the second substrate; and curing the composition under ambient conditions or slightly thermal conditions. For example, the composition may be applied to either one or both of the substrate materials being bonded to form an adhesive bond there between and the substrates may be aligned and pressure and/or spacers may be added to control bond thickness. The composition may be applied to cleaned or uncleaned (i.e., including oily or oiled) substrate surfaces.

The composition may be injected or otherwise placed in a die caster or a mould and cured under ambient conditions or by exposure to an external energy source, for example such as by heating to a temperature of less than 180° C., such as less than 130° C., such as less than 90° C. to form a part or a member and optionally may be machined to a particular configuration.

### 3-D Printing

Compositions of the present disclosure may be applied or deposited using any suitable method, including those aforementioned. Alternatively, the composition may be casted, extruded, molded, or machined to form a part or a member in a cured state.

The compositions disclosed herein may be used in any suitable additive manufacturing technology, such as three-dimensional (3D) printing, extrusion, jetting, and binder jetting. Additive manufacturing refers to a process of producing a part or member by constructing it in layers, such as one layer at a time.

The present disclosure is also directed to the production of structural articles, such as by way of a non-limiting example, sound damping pads, using an additive manufacturing process, such as 3D printing. 3D printing refers to a computerized process, optionally including artificial intelligence modulation, by which materials are printed or deposited in successive layers to produce a 3D part or member, such as, by way of a non-limiting example, sound damping pads in a battery assembly. A 3D part or member may be produced by depositing successive portions or layers over a base of any spatial configuration and thereafter depositing additional portions or layers over the underlying deposited portion or layer and/or adjacent to the previously deposited portion or layer to produce the 3D printed part or member.

It will be appreciated that the configuration of the 3D printing process, including the selection of suitable deposition equipment, depends on a number of factors such as the deposition volume, the viscosity of the composition and the complexity of the part being fabricated. Any suitable mixing, delivery, and 3D printing equipment as known to those skilled in the art, may be used. Compositions may be printed or deposited in any size and/or shape of droplets or extrudate, and in any patterns to produce the 3D structure.

Compositions as disclosed herein may be applied or deposited by any suitable 3D printing method as known to those skilled in the art. First and second components of 2K compositions may be mixed and then deposited, or the first and second components may be deposited separately, such as simultaneously and/or sequentially.

First and second components may be premixed, i.e., mixed together, prior to application, and then deposited. The mixture may be reacted or thermoset when the material is deposited; the deposited reaction mixture may react at least in part after deposition and may also react with previously deposited portions and/or subsequently deposited portions of the article such as underlying layers or overlying layers of the article.

In a non-limiting example, the first and two components may be released from their individual storage containers and pushed, such as pumped through conduits, such as hoses, to a mixer, such as a static or dynamic mixer, wherein the composition may be mixed for a time sufficient to homogenize the composition, wherein the composition may then be released through an outlet. The outlet may be a deposition device, such as a printing head, and/or the materials may exit the mixing unit and be pushed, such as by a pump, through a conduit, such as a hose, to the printing head. The printing head may optionally be mounted on a 3D rotational robotic arm to allow delivery of 3D print compositions to any base in any spatial configuration and/or the base may be manipulated in any spatial configuration during the 3D printing process.

Alternatively, first and second components may be deposited independently from different printing heads. The first component may be deposited from one printing head and the second component may be deposited from a second printing head. The first and second components may be deposited in any pattern such that the first and second components comprising any deposited layer can react together as well as react with underlying and/or overlying layers to produce the 3D printed part or member.

Methods provided by the present disclosure include printing the composition on a fabricated part. Methods provided by the present disclosure include directly printing parts.

Using the methods provided by the present disclosure parts can be fabricated. The entire part can be formed from one of the compositions disclosed herein, one or more portions of a part can be formed from one of the compositions disclosed herein, one or more different portions of a part can be formed using the compositions disclosed herein, and/or one or more surfaces of a part can be formed from a composition provided by the present disclosure. In addition, internal regions of a part can be formed from a composition provided by the present disclosure.

### Coatings and Formed Parts and Uses Thereof

Compositions disclosed herein may be used to form coatings having:
(a) a lap shear strength of at least 25 MPa measured according to ASTM D1002-10 using 2024-T3 aluminum substrate of 1.6 mm thickness using an INSTRON 5567 machine in tensile mode with a pull rate of 1.3 mm per minute, such as at least 26 MPa, such as at least such as at least 27 MPa, such as at least 28 MPa, such as at least 29 MPa, such as at least 30 MPa, such as at least 31 MPa, such as at least 32 MPa, such as at least 33 MPa, such as at least 34 MPa, such as at least 36 MPa;
(b) a wedge impact peel resistance at ambient temperature of at least 10 N/mm tested according to ISO 11343 Dynamic Resistance to Cleavage testing using 5754 aluminum of 1.2 mm thickness using an INSTRON CEAST 9350 drop tower model at an impact speed of 2 m/sec, such as at least 12 N/mm, such as at least 14 N/mm, such as at least 16 N/mm, such as at least 18 N/mm, such as at least 20 N/mm, such as at least 22 N/mm, such as at least 24 N/mm, such as at least 26 N/mm, such as at least 28 N/mm, such as at least 30 N/mm, such as at least 32 N/mm, such as at least 34 N/mm; and
(c) a wedge impact peel resistance at −40° C. of at least 3.0 N/mm, wherein wedge impact peel resistance at both ambient and −40° C. tested according to ISO 11343 Dynamic Resistance to Cleavage testing using 5754 aluminum of 1.2 mm thickness using an INSTRON CEAST 9350 drop tower model at an impact speed of 2 m/sec, with samples being conditioned at −40° C. for at least 30 minutes before testing, such as at least 5 N/mm, such as at least 6 N/mm, such as at least 8 N/mm, such as at least 10 N/mm, such as at least 12 N/mm, such as at least 14 N/mm, such as at least 16 N/mm, such as at least 18 N/mm, such as at least 20 N/mm, such as at least 22 N/mm, such as at least 24 N/mm, such as at least 26 N/mm, such as at least 28 N/mm, such as at least 30 N/mm, such as at least 32 N/mm.

### Substrates

The substrates that may be coated by the disclosed herein are not limited. Suitable substrates include, but are not limited to, materials such as metals or metal alloys, polymeric materials such as hard plastics including filled and unfilled thermoplastic materials or thermoset materials, or composite materials. Other suitable substrates include, but are not limited to, glass or natural materials such as wood. For example, suitable substrates include rigid metal substrates such as ferrous metals, aluminum, aluminum alloys, magnesium titanium, copper, and other metal and alloy substrates. The ferrous metal substrates may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. Aluminum alloys of the 1XXX, 2XXX, 3XXX, 4XXX, 5XXX, 6XXX, 7XXX, or 8XXX series as well as clad aluminum alloys and cast aluminum alloys of the A356, 1XX.X, 2XX.X, 3XX.X, 4XX.X, 5XX.X, 6XX.X, 7XX.X, or 8XX.X series also may be used as the substrate. Magnesium alloys of the AZ31B, AZ91C, AM60B, or EV31A series also may be used as the substrate. The substrate also may comprise titanium and/or titanium alloys of grades 1-36 including H grade variants. Other suitable non-ferrous metals include copper and magnesium, as well as alloys of these materials. In examples, the substrate may be a multi-metal article. As used herein, the term “multi-metal article” refers to (1) an article that has a surface comprised of a first metal and a surface comprised of a second metal that is different from the first metal, (2) a first article that has a surface comprised of a first metal and a second article that has a surface comprised of a second metal that is different from the first metal, or (3) both (1) and (2). Suitable metal substrates include those that are used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, and industrial structures and components. As used herein, “vehicle” or variations thereof includes, but is not limited to, civilian, commercial, and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091. The substrate may comprise a composite material such as a plastic or a fiberglass composite. The substrate may be a fiberglass and/or carbon fiber composite. The compositions disclosed herein are particularly suitable for use in various industrial or transportation applications including automotive, light, and heavy commercial vehicles, marine, or aerospace.

Substrates that may be coated by the composition of the present disclosure or the coating formed therefrom are not limited. Suitable substrates for use in the present disclosure include those that are used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, and industrial structures and components. As used herein, “vehicle” or variations thereof includes, but is not limited to, civilian, commercial, and military aircraft, and/or land vehicles such as cars, motorcycles, and/or trucks. The metal substrate also may be in the form of, for example, a sheet of metal or a fabricated part. The compositions of the present disclosure are particularly suitable for use in various industrial or transportation applications including automotive, light, and heavy commercial vehicles, marine, or aerospace.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1

Synthesis of Auxiliary Toughening Agent A: To a round-bottom flask was added 134.7 g methylhexahydrophthalic anhydride, 520.1 g Epon 863, and 205.9 g Capa 4101. The mixture was placed under a nitrogen blanket, heated to 90° C., and stirred for 30 minutes. A mixture of 0.3 g triphenylphosphine in 50.8 g Epon 863 was added and the mixture was slowly heated to 120° C. for 4 hours. An additional 197.0 g of Epon 863 was added, the mixture was stirred for an additional 15 minutes at 120° C., before allowing to cool, resulting in a resin with a measured epoxy equivalent weight of 304 g/mol to 324 g/mol. The resulting material comprised 43 percent auxiliary toughening agent and a 57 percent unreacted (excess) Epon 863, and this unreacted amount was considered as part of the epoxy-containing component.

Synthesis of Etheramine-Epoxy Adduct A: To a round-bottom flask was added 1104.0 g Jeffamine EDR-148. The material was placed under a nitrogen blanket and heated to 70° C. 967.3 g of Epon 863 was added dropwise via an addition funnel, ensuring that the temperature did not exceed 100° C. during the addition. The mixture was held at 70° C. until thin layer chromatography analysis confirmed consumption of the Epon 863. The resulting material had a theoretical NH equivalent weight of 85 g/mol.

Alternate amine-functional epoxy-amine adducts were synthesized by a similar procedure using the indicated amine and epoxy resins in Table 1. All etheramine-epoxy adducts in Table 1 were prepared at a 5.25:1.0 NH:E ratio. All amounts listed are in grams.

TABLE 1
Etheramine-Epoxy Adducts A-F

| Component | A | B | C | D | E | F |
|---|---|---|---|---|---|---|
| Jeffamine EDR-148¹ | 1104.0 | | | 10.9 | 15.0 | 9.1 |
| Ancamine 1922A² | | 17.1 | 17.1 | | | |
| Epon 863³ | 967.3 | 10.0 | | | | |
| Epon 828⁴ | | | 11.1 | | | |
| Eponex 1510⁵ | | | | 12.0 | | |
| Heloxy BD⁶ | | | | | 10.0 | |
| D.E.R. 732⁷ | | | | | | 15.0 |

¹Bis(aminoethyl) ethylene glycol available from Huntsman
²Bis(aminopropyl) diethylene glycol available from Evonik
³Bisphenol F epoxy resin available from Hexion
⁴Bisphenol A epoxy resin available from Hexion
⁵Hydrogenated bisphenol A diglycidyl ether available from Hexion
⁶1,4-butanediol diglycidyl ether available from Hexion
⁷Polypropylene glycol diglycidyl ether, epoxy eq. wt. = 320 available from Olin Epoxy

Pretreatment Composition: A deoxidizing composition was prepared as described in PCT Publ. No. 2021040865A1, par. [0276].

Lap shear specimens were prepared with Compositions I through XXV according to ASTM D1002-10. The substrate used was 2024-T3 aluminum alloy panels measuring 25.4 mm×101.6 mm×1.6 mm. The panels were cleaned with acetone, rinsed with deionized water, immersed in the indicated pretreatment composition at 100° F. for 1 minute, rinsed with deionized water, and dried. Composition was applied to one end of a panel covering the full 25.4 mm width and ≥12.7 mm from one end. A second pretreated aluminum panel was then placed over the composition layer in an end-to-end fashion, resulting in a bond area of 25.4 mm×12.7 mm. Lap joints were secured with metal clips and excess composition cleaned, leaving a 450 fillet. Lap joints were allowed to cure at ambient temperature for 7 days. The lap joint specimens were tested using an INSTRON model 5567 in tensile mode with 25.4 mm of aluminum substrate in each grip and at a pull rate of 1.3 mm per minute (in accordance with ASTM D1002-10).

Wedge impact peel samples were prepared and tested in accordance with ISO 11343; the substrate used was 5754 aluminum of 1.2 mm thickness. Substrates were cleaned with acetone, rinsed with deionized water, immersed in the pretreatment composition at 100° F. for 1 minute, rinsed with deionized water, and dried. Specimens were tested according to ISO 11343 Dynamic Resistance to Cleavage testing using an INSTRON CEAST 9350 drop tower model at an impact speed of 2 m/sec. Samples tested at −40° C. were conditioned at −40° C. for at least 30 minutes before testing.

Compositions were prepared from the mixtures of ingredients shown in Table 2-7. All amounts listed are in grams. All compositions were prepared at an amine-hydrogen to epoxy equivalence of 1:1, with elastomeric particle loading of 9-10 wt %, an auxiliary toughening loading of 9-10 wt %, and a reinforcing filler loading of 10 wt %, except where omitted for comparison. Compositions XIV-XVI were prepared with elastomeric particle loading of 9-10 wt %, auxiliary toughening agent loading of 13-14 wt %, and reinforcing filler loading of 4-5 wt %. Epoxy resins, auxiliary toughening agents, fillers, and additives were premixed, then accelerators, curing agents, and spacer beads were added, mixed, and then lap shear specimens were immediately prepared as described above. Specimens were allowed to cure at ambient conditions for 1 week prior to testing.

TABLE 2
Compositions I-IV

| Components | I (Comp.) | II | III | IV |
|---|---|---|---|---|
| Kane Ace MX-136¹ | 11.00 | 12.10 | 12.10 | 11.80 |
| Epon 863 | 5.25 | | 2.30 | 3.35 |
| Auxiliary Toughening | | 7.20 | | |
| Agent A | | | | |
| Ancarez 2364² | | | 4.35 | |
| Miramer PU 2100³ | | | | 2.98 |
| Silquest A-187⁴ | 0.28 | 0.30 | 0.30 | 0.30 |
| Aerosil R202⁵ | 0.55 | 0.61 | 0.60 | 0.60 |
| NYAD M200⁶ | 2.75 | 3.10 | 3.05 | 2.98 |
| Etheramine-Epoxy | 7.05 | 6.78 | 6.78 | 6.78 |
| Adduct A | | | | |
| Ancamine K54⁷ | 0.27 | 0.30 | 0.30 | 0.30 |
| 10 mil Spacer Beads | 0.55 | 0.61 | 0.60 | 0.60 |
| Total | 27.70 | 31.00 | 30.38 | 29.69 |
| Lap Shear Strength | 32.4 ± 0.3 | 32.1 ± 0.6 | 26.6 ± 0.8 | 31.0 ± 0.5 |
| [MPa] | | | | |
| Wedge Impact Peel | 3.4 ± 3.4 | 17.1 ± 2.3 | 14.1 ± 5.6 | 16.6 ± 9.9 |
| Resistance, Ambient | | | | |
| [N/mm] | | | | |
| Wedge Impact Peel | 2.7 ± 2.6 | 16.9 ± 9.5 | 26.7 ± 4.8 | 21.4 ± 6.9 |
| Resistance, −40° C. | | | | |
| [N/mm] | | | | |

¹Blend of bisphenol F epoxy resin and ~100 nm diameter core-shell polybutadiene rubber available from Kaneka Corporation
²Acrylate-functional urethane resin in bisphenol A epoxy resin available from Evonik Acrylate-functional urethane resin available from Miwon
⁴Gamma-glycidoxypropyltrimethoxysilane available from Momentive
⁵Hydrophobic fumed silica available from Evonik
⁶Wollastonite (Median particle size: 20 × 100 μm) available from Imerys
⁷2,4,6-tris(N,N-dimethylaminomethyl)phenol available from Evonik

The results demonstrate that a combination of elastomeric particles and auxiliary toughening agent are required to obtain a combination of lap shear and frozen wedge impact peel resistance with etheramine-epoxy adduct curing agents. Furthermore, the results demonstrate that acrylate-functional urethanes and epoxy-polyester adducts give improved −40° C. wedge impact.

TABLE 3
Compositions V-IX

| Components | V | VI | VII | XIII (Comp.) | IX (Comp.) |
|---|---|---|---|---|---|
| Kane Ace MX-136 | 12.10 | 12.10 | 12.10 | 11.10 | 11.50 |
| Epon 863 | | | | 1.30 | 0.65 |
| Auxiliary Toughening | 7.20 | 7.20 | 7.20 | 6.40 | 6.65 |
| Agent A | | | | | |
| Silquest A-187 | 0.30 | 0.32 | 0.32 | 0.28 | 0.30 |
| Aerosil R202 | 0.61 | 0.65 | 0.66 | 0.56 | 0.56 |
| NYAD M200 | 3.10 | 3.30 | 3.34 | 2.77 | 2.85 |
| Etheramine-Epoxy | 6.78 | | | | |
| Adduct A | | | | | |
| Etheramine-Epoxy | | 8.55 | | | |
| Adduct B | | | | | |
| Etheramine-Epoxy | | | 8.90 | | |
| Adduct C | | | | | |
| Ancamine 1922A | | | | 4.37 | |
| Jeffamine RFD-270¹ | | | | | 5.24 |
| Ancamine K54 | 0.30 | 0.32 | 0.32 | 0.28 | 0.30 |
| 10 mil Spacer Beads | 0.61 | 0.65 | 0.66 | 0.56 | 0.56 |
| Total | 31.00 | 33.09 | 33.50 | 27.62 | 28.61 |

Adhesive Performance

| | | | | | |
|---|---|---|---|---|---|
| Lap Shear Strength | 32.2 ± 1.7 | 31.5 ± 0.8 | 31.9 ± 1.8 | 29.9 ± 0.8 | 28.3 ± 1.1 |
| [MPa] | | | | | |
| Wedge Impact Peel | 22.9 ± 2.2 | 26.2 ± 1.3 | 27.3 ± 2.7 | 4.7 ± 4.7 | 14.3 ± 0.5 |
| Resistance, Ambient | | | | | |
| [N/mm] | | | | | |
| Wedge Impact Peel | 16.9 ± 10.4 | 32.6 ± 9.9 | 31.2 ± 5.9 | 4.2 ± 4.2 | 1.3 ± 0.2 |
| Resistance, −40° C. | | | | | |
| [N/mm] | | | | | |

¹Aliphatic amine containing cycloaliphatic and polyetheramine segments available from Huntsman

The results demonstrate that etheramine-epoxy adduct curing agents give significantly improved wedge impact peel resistance relative to etheramine curing agents alone or cycloaliphatic-modified polyetheramine curing agents.

TABLE 4
Compositions X-XIII

| Components | V (Rep). | X | XI | XII (Comp.) | XIII (Comp.) |
|---|---|---|---|---|---|
| Kane Ace MX-136 | 12.10 | 12.10 | 11.70 | 12.10 | 11.10 |
| Epon 863 | | | 0.44 | | 1.25 |
| Auxiliary Toughening | 7.20 | 7.20 | 7.00 | 7.20 | 6.60 |
| Agent A | | | | | |
| Silquest A-187 | 0.30 | 0.32 | 0.30 | 0.33 | 0.28 |
| Aerosil R202 | 0.61 | 0.65 | 0.60 | 0.67 | 0.56 |
| NYAD M200 | 3.10 | 3.30 | 3.00 | 3.10 | 2.85 |
| Etheramine-Epoxy | 6.78 | | | | 1.70 |
| Adduct A | | | | | |
| Etheramine-Epoxy | | 7.64 | | | |
| Adduct D | | | | | |
| Etheramine-Epoxy | | | 6.05 | | |
| Adduct E | | | | | |
| Etheramine-Epoxy | | | | 9.60 | |
| Adduct F | | | | | |
| Bis(4- | | | | | 3.16 |
| aminocyclohexyl)methane¹ | | | | | |
| Ancamine K54 | 0.30 | 0.32 | 0.31 | 0.33 | 0.28 |
| 10 mil Spacer Beads | 0.61 | 0.65 | 0.60 | 0.67 | 0.56 |
| Total | 31.00 | 32.08 | 30.00 | 34.00 | 28.34 |

Adhesive Performance

| | | | | | |
|---|---|---|---|---|---|
| Lap Shear Strength | 32.2 ± 1.7 | 31.6 ± 1.3 | 31.1 ± 1.2 | 21.5 ± 1.0 | 29.1 ± 0.2 |
| [MPa] | | | | | |
| Wedge Impact Peel | 22.9 ± 2.2 | 23.7 ± 5.1 | 28.6 ± 3.8 | 28.2 ± 3.9 | 2.3 ± 2.3 |
| Resistance, Ambient | | | | | |
| [N/mm] | | | | | |
| Wedge Impact Peel | 16.9 ± 10.4 | 17.6 ± 4.6 | 26.5 ± 0.5 | 27.5 ± 0.5 | 0.3 ± 0.3 |
| Resistance, −40° C. | | | | | |
| [N/mm] | | | | | |

¹Available from Sigma-Aldrich

The results demonstrate that etheramine-epoxy adducts synthesized from low molecular weight epoxy resin are required to achieve a combination of high lap shear strength and −40° C. wedge impact peel resistance. Additionally, comparative example XIII demonstrates that use of a cycloaliphatic amine as a co-curing agent does not provide wedge impact peel resistance.

TABLE 5
Compositions XIV-XVI

| Components | XIV | XV | XVI |
|---|---|---|---|
| Kane Ace MX-136 | 11.10 | 11.10 | 11.10 |
| Epon 863 | 1.55 | 1.55 | 1.55 |
| Auxiliary Toughening | 6.10 | 6.10 | 6.10 |
| Agent A | | | |
| Silquest A-187 | 0.26 | 0.26 | 0.26 |
| Aerosil R202 | 0.55 | 0.55 | 0.55 |
| Socal 31¹ | | | 0.65 |
| NYAD M400² | | 1.30 | 0.65 |
| Etheramine-Epoxy | 6.70 | 6.70 | 6.70 |
| Adduct A | | | |
| Ancamine K54 | 0.27 | 0.27 | 0.27 |
| 10 mil Spacer Beads | 0.55 | 0.55 | 0.55 |
| Total | 27.08 | 28.38 | 28.38 |
| Lap Shear Strength | 33.4 ± 1.5 | 33.9 ± 1.5 | 34.2 ± 0.7 |
| [MPa] | | | |
| Wedge Impact Peel | 13.4 ± 13.4 | 29.0 ± 4.2 | 20.4 ± 4.0 |
| Resistance, Ambient | | | |
| [N/mm] | | | |
| Wedge Impact Peel | 6.5 ± 6.5 | 14.7 ± 5.0 | 17.7 ± 11.8 |
| Resistance, −40° C. | | | |
| [N/mm] | | | |

¹Ultrafine precipitated calcium carbonate (Particle diameter: 0.05-0.1 μm) available from Imerys
²Wollastonite (Median particle size: 9 × 27 μm) available from Imerys

The results demonstrate that addition of reinforcing filler provides significantly improved low temperature wedge impact peel resistance when combined with etheramine-epoxy adduct curing agents and auxiliary toughening agents.

TABLE 6
Compositions XVII-XX

| Components | V (Rep.) | XVII | XIII | XIX | XX |
|---|---|---|---|---|---|
| Kane Ace MX-136 | 12.10 | 12.10 | 12.10 | 12.10 | 12.10 |
| Auxiliary Toughening | 7.20 | 7.20 | 7.20 | 7.20 | 7.20 |
| Agent A | | | | | |
| Silquest A-187 | 0.30 | 0.30 | 0.30 | 0.30 | 0.30 |
| Aerosil R202 | 0.61 | 0.61 | 0.61 | 0.61 | 0.61 |
| NYAD M200 | 3.10 | | | | |
| NYAD G¹ | | 3.10 | | | |
| NYAD M9000² | | | 3.10 | | |
| Socal 31 | | | | 3.10 | |
| TiONA 595³ | | | | | 3.10 |
| Etheramine-Epoxy | 6.78 | 6.78 | 6.78 | 6.78 | 6.78 |
| Adduct A | | | | | |
| Ancamine K54 | 0.30 | 0.30 | 0.30 | 0.30 | 0.30 |
| 10 mil Spacer Beads | 0.61 | 0.61 | 0.61 | 0.61 | 0.61 |
| Total | 31.00 | 31.00 | 31.00 | 31.00 | 31.00 |

Adhesive Performance

| | | | | | |
|---|---|---|---|---|---|
| Lap Shear Strength | 32.2 ± 1.7 | 29.3 ± 0.7 | 32.7 ± 0.2 | 34.3 ± 1.3 | 32.8 ± 1.6 |
| [MPa] | | | | | |
| Wedge Impact Peel | 22.9 ± 2.2 | 24.6 ± 0.7 | 20.7 ± 6.7 | 27.8 ± 1.6 | 25.4 ± 5.5 |
| Resistance, Ambient | | | | | |
| [N/mm] | | | | | |
| Wedge Impact Peel | 16.9 ± 10.4 | 13.8 ± 1.2 | 5.3 ± 0.6 | 3.0 ± 1.2 | 5.9 ± 2.4 |
| Resistance, −40° C. | | | | | |
| [N/mm] | | | | | |

¹Wollastonite (Median particle size: 55 × 825 μm) available from Imerys
²Wollastonite (Median particle size: 3 μm) available from Imerys
³Titanium dioxide (Median particle size: 0.2 μm) available from Tronox

TABLE 7
Compositions XXI-XXV

| Components | XXI | XXII | XXIII | XXIV | XXV |
|---|---|---|---|---|---|
| Kane Ace MX-136 | 12.10 | 12.10 | 12.10 | 12.10 | 12.10 |
| Auxiliary Toughening | 7.20 | 7.20 | 7.20 | 7.20 | 7.20 |
| Agent A | | | | | |
| Silquest A-187 | 0.30 | 0.30 | 0.30 | 0.30 | 0.30 |
| Aerosil R202 | 0.61 | 0.61 | 0.61 | 0.61 | 0.61 |
| ACF300¹ | 3.10 | | | | |
| Nicron 674² | | 3.10 | | | |
| Vertal 97³ | | | 3.10 | | |
| Monarch 120⁴ | | | | | |
| PX35MF200⁵ | | | | 3.10 | |
| Miox SG⁶ | | | | | 3.10 |
| Etheramine-Epoxy | 6.78 | 6.78 | 6.78 | 6.78 | 6.78 |
| Adduct A | | | | | |
| Ancamine K54 | 0.30 | 0.30 | 0.30 | 0.30 | 0.30 |
| 10 mil Spacer Beads | 0.61 | 0.61 | 0.61 | 0.61 | 0.61 |
| Total | 31.00 | 31.00 | 31.00 | 31.00 | 31.00 |
| Lap Shear Strength | 30.2 ± 1.4 | 29.5 ± 0.5 | 28.2 ± 0.6 | 29.0 ± 0.8 | 31.4 ± 0.6 |
| [MPa] | | | | | |
| Wedge Impact Peel | 28.5 ± 3.5 | 12.4 ± 1.7 | 18.0 ± 0.5 | 28.6 ± 0.6 | 28.2 ± 2.4 |
| Resistance, Ambient | | | | | |
| [N/mm] | | | | | |
| Wedge Impact Peel | 15.7 ± 6.6 | 3.4 ± 1.2 | 11.8 ± 0.1 | 13.0 ± 1.3 | 26.6 ± 0.8 |
| Resistance, −40° C. | | | | | |
| [N/mm] | | | | | |

¹Glass flake (Particle size: 0-30% 45-53 μm, 70-100% <45 μm) available from Ameriflake Glass Company
²Talc (Median particle size: 1.9 μm) available from Imerys
³Talc (Median particle size: 15 μm) available from Imerys
⁴Carbon black (Median particle size: 0.06 μm) available from Cabot
⁵Milled carbon fiber (Median particle size: 7.2 × 150 μm) available from Zoltek
⁶Micaceous iron oxide (Median particle size: 35 μm) available from The Kish Company

The results demonstrate that addition of reinforcing filler provides significantly improved low temperature wedge impact peel resistance when combined with etheramine-epoxy adduct curing agents and auxiliary toughening agents. The results demonstrate further improved performance when the reinforcing filler comprises a platy filler, and when the reinforcing filler has a particle size greater than 10 microns in a dimension.

Whereas particular features of the present disclosure have been described above for purposes of illustration, it will be evident to those skilled in the art that numerous variations of the details of the coating composition, coating, and methods disclosed herein may be made without departing from the scope in the appended claims.

We claim:

1. A composition comprising:
a first component comprising an epoxy-containing compound (E1);
a second component comprising an amine-functional aliphatic etheramine-epoxy adduct (A1);
elastomeric particles; and
an auxiliary toughening agent.

2-3. (canceled)

4. The composition of claim 1, wherein the epoxy-containing compound (E1) comprises an epoxide equivalent weight of 80 g/eq to 300 g/eq.

5. The composition of claim 1, wherein the composition comprises:
(a) the epoxy-containing compound (E1) in an amount of 10 percent by weight to 100 percent by weight based on total weight of the first component;
(b) the amine-functional aliphatic etheramine-epoxy adduct (A1) in an amount of 10 percent by weight to 100 percent by weight based on total weight of the second component;
(c) the elastomeric particles in an amount of 5 percent by weight to 25 percent by weight based on total weight of the composition; and/or
(d) the auxiliary toughening agent in an amount of 1 percent by weight to 25 percent by weight based on total weight of the composition.

6. The composition of claim 1, wherein the first component further comprises a monoepoxide, a reinforcing filler, an accelerator, and/or an additive.

7. (canceled)

8. The composition of claim 1, wherein the amine-functional aliphatic etheramine-epoxy adduct (A1) is substantially free of epoxide-functional groups.

9. (canceled)

10. The composition of claim 1, wherein the amine-functional aliphatic etheramine-epoxy adduct (A1) comprises a reaction product of reactants comprising an aliphatic etheramine (A2) and an epoxy-containing compound (E2).

11-12. (canceled)

13. The composition of claim 10, wherein the aliphatic etheramine (A2) comprises a primary amine functional group adjacent to a methylene group.

14. The composition of claim 10, wherein the aliphatic etheramine (A2) comprises a molecular weight of 104 g/mol to 300 g/mol.

15. (canceled)

16. The composition of claim 10, wherein the epoxy-containing compound (E2):
(a) comprises an aromatic group;
(b) comprises a molecular weight of 160 g/mol to 600 g/mol measured by mass spectrometry; and/or
(c) an epoxide equivalent weight of 85 g/eq to 300 g/eq.

17. The composition of claim 10, wherein the reactants comprise the aliphatic etheramine (A2) in an amount sufficient to provide a molar ratio of amine-hydrogens from the aliphatic etheramine (A2) to epoxide functional groups from the epoxy-containing compound (E2) of at least 3:1.

18-27. (canceled)

28. The composition of claim 1, wherein the auxiliary toughening agent comprises:
(a) an epoxide equivalent weight of 150 g/eq to 2000 g/eq; and/or
(b) an amine hydrogen equivalent weight of 150 g/eq to 2000 g/eq.

29-34. (canceled)

35. A method of coating a substrate comprising contacting a portion of a surface of the substrate with the composition claim 1.

36. (canceled)

37. The method of claim 35, further comprising contacting a surface of a second substrate to the composition such that the composition is located between the substrate and the second substrate

38. A method of forming an article, comprising extruding the composition of claim 1.

39-40. (canceled)

41. A substrate comprising a coating formed from the composition of claim 1 on a portion of a surface of the substrate.

42-44. (canceled)

45. The substrate of claim 41, wherein the coating comprises: (a) a lap shear strength of at least 25 MPa measured according to ASTM D1002-10 using 2024-T3 aluminum substrate of 1.6 mm thickness using an INSTRON 5567 machine in tensile mode with a pull rate of 1.3 mm per minute; (b) a wedge impact at ambient temperature of at least 10 N/mm and (c) a wedge impact at −40° C. of at least 3.0 N/mm, wherein wedge impact at both ambient and −40° C. tested according to ISO 11343 Dynamic Resistance to Cleavage testing using 5754 aluminum substrate of 1.2 mm thickness using an INSTRON CEAST 9350 drop tower model at an impact speed of 2 m/sec, with samples being conditioned at the desired temperature for at least 30 minutes before testing.

46-47. (canceled)

48. The substrate of claim 41, wherein the substrate comprises an article, a part, or combinations thereof.

49. The substrate of claim 48, wherein the article comprises a vehicle, an appliance, a personal electronic device, a circuit board, a multi-metal substrate, or combinations thereof, and/or wherein the part comprises a vehicular part.

50. (canceled)

51. The substrate of claim 49, wherein the vehicle comprises a land vehicle or an aircraft.

52-53. (canceled)
